(19) United States
(12) Patent Application Publication
(10) Pub. No.: US 2017/0016797 A1
(43) Pub. Date: Jan. 19, 2017

(54) APPARATUS AND METHOD OF MONITORING GAS BASED ON VARIATION IN SOUND FIELD SPECTRUM

(71) Applicant: ELECTRONICS AND TELECOMMUNICATIONS RESEARCH INSTITUTE, Daejeon (KR)

(72) Inventors: Kang-Ho PARK, Daejeon (KR); Sung Q LEE, Daejeon (KR)

(21) Appl. No.: 15/155,346

(22) Filed: May 16, 2016

(30) Foreign Application Priority Data
Jul. 15, 2015 (KR) 10-2015-0100547

(51) Int. Cl. G01M 3/24; G01N 29/02

(52) U.S. Cl. CPC G01M 3/24; G01N 29/02; G01N 2291/0215

(57) ABSTRACT

A gas monitoring apparatus according to the inventive concept includes a sound generator, a sound receiver, and a sound field signal processor. The sound generator continuously outputs a sound signal into a gas monitoring space. The sound receiver receives a sound signal reflected from the gas monitoring space. The sound field signal processor obtains sound field information on the received sound signal, calculates a sound field spectrum for the sound field information, uses a correlation between the calculated sound field spectrum and a reference sound field spectrum, and determines whether there are gas leak and mixing in the gas monitoring space, wherein the reference sound field spectrum is a sound field spectrum according to frequency measured in a case where a gas is not leaked in the gas monitoring space, and the sound signal is formed by a linear sum of sine waves that have a plurality of frequency components.

### CROSS-REFERENCE TO RELATED APPLICATIONS

This U.S. non-provisional patent application claims priority under 35 U.S.C. §119 of Korean Patent Application No. 10-2015-0100547, filed on Jul. 15, 2015, the entire contents of which are hereby incorporated by reference.

### BACKGROUND

The present disclosure herein relates to an apparatus and method for monitoring a gas, and more particularly, to an apparatus and method for monitoring a gas based on a variation in sound field spectrum.

A gas sensor technology that uses a sound technology to sense a gas leak and a variation in gas density has been devised for years. Methods of sensing the gas include a method of sensing a sound or ultrasonic wave generated when the gas is leaked, a method of measuring the propagation speed of the sound that depends on the type and density of the gas, a method of sensing a variation in sound stationary wave varying by the mixing of gases in a closed space, a method of measuring a variation in sound signal by a variation in internal gas in a sound wave generation and reception sensor, and a method of using a laser to irradiate light and analyze a generated sound.

However, it is significantly difficult to sense a gas leak that occurs at any position in spaces of various shapes. Thus, in order to prevent various accidents that include explosions, fires, injuries, and suffocation caused by such a gas leak, there is a need for a technology that senses gas leak and mixing that occur at any position in the whole gas monitoring space.

As the related art, there is a sound gas sensor technology that measures a sound speed from the wavelength of a sound stationary wave that is determined by a chamber structure and gas mixing, the mixing level of a gas in a chamber filled with a gas, and measures the mixing ratio or density of a gas based thereon. However, the patented invention has drawbacks in that it needs to use a gas chamber structure of a specific shape in order to find the mixing ratio of a gas and is limited to a frequency corresponding to a stationary wave. Thus, there is a drawback in that it is difficult to measure a gas leak or mixing that occurs at any position in spaces of various shapes, and an amount of leak gas, with this technology.

As another related art, there is a technology that discharges a gas from a gas chamber having a structure of a specific shape as well, discharges a sound wave, measures a reflected time to find the speed of the sound wave and thus measure the concentration of a specific gas. However, since the patented invention also needs to use a gas chamber that is manufactured in a specific shape and in a certain size, there is a drawback in that it is difficult to sense a gas leak and mixing that occurs at any position in spaces of various shapes where a user may not find it.

As another related art, there is a technology that senses a variation in hydrogen gas that is generated by a water leak from a high-speed cooling reactor having a structure of a specific shape, by the measuring of a variation in signal from an ultrasonic generation and reception sensor that is installed near it. However, since the patented invention is also limited to the high-speed cooling reactor manufactured in a specific shape and in a certain size and the sensing range of an ultrasonic wave is limited, there are drawbacks in that it is difficult to sense a gas leak and mixing that occurs at any position in spaces of various shapes and it is difficult to quantitatively derive an amount of leak gas.

### SUMMARY

The present disclosure provides an apparatus and method of monitoring a gas that senses the presence and absence of gas leak and mixing situations that occur at any position in a space of any shape from the correlation between sound field spectra based on the variation pattern of the sound field spectra according to the frequency of a multi-tone sound source in a monitoring space.

An embodiment of the inventive concept provides a gas monitoring apparatus including a sound generator configured to continuously output a sound signal into a gas monitoring space; a sound receiver configured to receive a sound signal reflected from the gas monitoring space; and a sound field signal processor configured to obtain sound field information on the received sound signal, calculate a sound field spectrum for the sound field information, use a correlation between the calculated sound field spectrum and a reference sound field spectrum, and determine whether there are gas leak and mixing in the gas monitoring space, wherein the reference sound field spectrum is a sound field spectrum according to frequency measured in a case where a gas is not leaked in the gas monitoring space, and the sound signal is formed by a linear sum of sine waves that have a plurality of frequency components.

In an embodiment, the correlation may be obtained by calculating of a cross correlation coefficient between the reference sound field spectrum and the sound field spectrum of the continuously output sound signal.

In an embodiment, the cross correlation coefficient may be calculated by using an equation below:

$${R}_{i , j} ( m ) = \frac{{\sum }_{n = 1}^{N - m} ( {S}_{j} ( n + m ) - mean ( {S}_{j} ) ) ( {S}_{i} ( n ) - mean ( {S}_{i} ) )}{\sqrt{{\sum }_{n = 1}^{N} {( {S}_{i} ( n ) - mean ( {S}_{i} ) )}^{2}} \sqrt{{\sum }_{n = 1}^{N} {( {S}_{j} ( n ) - mean ( {S}_{j} ) )}^{2}}} , m \geq 0 , \\ {R}_{i , j} ( m ) = {R}_{j , i} ( - m ) , m < 0$$

where R_{i,j} denotes a cross correlation coefficient between an ith measured sound field Sᵢ, and jth measured sound field Sⱼ, N denotes the number of channels of a multi-tone sound source, and m denotes a neighboring frequency interval of the multi-tone sound source as a unit of frequency shift value.

In an embodiment, the sound field information may be sound pressure or a phase of the sound signal, and the sound field signal processor may use a sound transfer function to calculate the sound pressure or phase.

In an embodiment, the sound field signal processor may be configured to calculate an index representing a frequency shift level of the sound field spectrum based on a correlation coefficient that is obtained when a multi-tone frequency between the reference sound field spectrum and the sound field spectrum of the continuous sound signal is used as a variable, and sense a type of leak gas, an amount of leak gas, and a leak speed in consideration of a direction of the frequency shift and a time for which the frequency shift is sustained.

In an embodiment, the sound field signal processor may be configured to compare the reference sound field spectrum and the measured sound field spectrum to determine as a gas leak situation in a case where a variation in sound field occurs, and analyze sound field spectra collected for a set period before determining the gas leak situation to sense an amount of leak gas.

In an embodiment, the sound field signal processor may be configured to analyze a variation pattern of a sound field spectrum according to time to sense a type of leak gas and a leak speed.

In an embodiment, the sound field signal processor may be configured to further obtain sensing information from a gas sensor installed in the gas monitoring space, and further use the obtained sensing information to calculate a type of leak gas and an amount of leak gas.

In an embodiment, the gas monitoring apparatus may further include an image capturing unit that is configured to obtain internal image information on of the gas monitoring space, wherein the image capturing unit may be configured to capture an internal image of the gas monitoring space in a case where gas leak and mixing situations occur.

In an embodiment, the gas monitoring apparatus may further include a communication unit that is configured to transmit, to an external device, presence and absence of a gas leak, a type of gas, an amount of leak gas, a leak speed, and image information.

In an embodiment of the inventive concept, a method of monitoring gas leak and mixing may include outputting, to a gas monitoring space, a multi-tone sound wave formed by a linear sum of sine waves that have a plurality of frequency components; receiving the output multi-tone sound wave; deriving sound field information on the received multi-tone sound wave and using the derived sound field information to obtain a sound field spectrum according to frequency; calculating a cross correlation coefficient between the obtained sound field spectrum according to frequency and a reference sound field spectrum; and comparing the calculated cross correlation coefficient with a set determination reference value to determine presence and absence of gas leak and mixing.

In an embodiment, the cross correlation coefficient may be calculated by using an equation below:

$${R}_{i , j} ( m ) = \frac{{\sum }_{n = 1}^{N - m} ( {S}_{j} ( n + m ) - mean ( {S}_{j} ) ) ( {S}_{i} ( n ) - mean ( {S}_{i} ) )}{\sqrt{{\sum }_{n = 1}^{N} {( {S}_{i} ( n ) - mean ( {S}_{i} ) )}^{2}} \sqrt{{\sum }_{n = 1}^{N} {( {S}_{j} ( n ) - mean ( {S}_{j} ) )}^{2}}} , m \geq 0 , \\ {R}_{i , j} ( m ) = {R}_{j , i} ( - m ) , m < 0$$

where R_{i,j} denotes a cross correlation coefficient between an ith measured sound field Sᵢ, and jth measured sound field Sⱼ, N denotes the number of channels of a multi-tone sound source, and m denotes a neighboring frequency interval of the multi-tone sound source as a unit of frequency shift value.

In an embodiment, the sound field information may be sound pressure or a phase of the sound signal, and a sound field signal processor may use a sound transfer function to calculate the sound pressure or phase.

In an embodiment, the method may further include calculating an index representing a frequency shift level of the sound field spectrum based on a correlation coefficient that is obtained when a multi-tone frequency between the reference sound field spectrum and the sound field spectrum of the continuous sound signal is used as a variable, and sensing a type of leak gas, an amount of leak gas, and a leak speed in consideration of a direction of the frequency shift and a time for which the frequency shift is sustained.

In an embodiment, the method may further include capturing an internal image of the gas monitoring space in a case where it is determined as gas leak and mixing situations.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram of a gas monitoring apparatus according to an embodiment of the inventive concept;

FIG. 2 is a conceptual view of a gas monitoring method using a gas monitoring apparatus according to an embodiment of the inventive concept;

FIG. 3 shows a situation in which a gas leak and mixing occur in a cube-shape gas monitoring space;

FIGS. 4A to 4C show results of simulation on a sound pressure level using finite element analysis in the case where a methane gas forms a layer in the gas monitoring space in FIG. 2;

FIGS. 5A to 5C show results of simulation on a sound pressure level using finite element analysis in the case where a propane gas forms a layer in the gas monitoring space in FIG. 2;

FIGS. 6A to 6C show results of simulation on a sound pressure level using finite element analysis in the case where a methane gas exists in a globe shape in the gas monitoring space in FIG. 2;

FIGS. 7A to 7C show results of simulation on a sound pressure level using finite element analysis in the case where a propane gas exists in a globe shape in the gas monitoring space in FIG. 2;

FIGS. 8A to 8C show sound field spectra calculated by the gas monitoring apparatus according to the inventive concept in the cases of FIGS. 4A to 4C;

FIGS. 9A to 9C show sound field spectra calculated by the gas monitoring apparatus according to the inventive concept in the cases of FIGS. 5A to 5C;

FIGS. 10A to 10C show sound field spectra calculated by the gas monitoring apparatus according to the inventive concept in the cases of FIGS. 6A to 6C;

FIGS. 11A to 11C show sound field spectra calculated by the gas monitoring apparatus according to the inventive concept in the cases of FIGS. 7A to 7C;

FIGS. 12A and 12B represent the cross correlation coefficient between a reference sound field spectrum in the case where the entire space is filled with the air and a sound field spectrum in the case where the methane gas forms a layer, according to a frequency shift;

FIGS. 13A and 13B represent the cross correlation coefficient between a reference sound field spectrum in the case where the entire space is filled with the air and a sound field spectrum in the case where the propane gas forms a layer, according to a frequency shift;

FIGS. 14A and 14B represent the cross correlation coefficient between a reference sound field spectrum in the case where the entire space is filled with the air and a sound field spectrum in the case where the methane gas forms a globe, according to a frequency shift;

FIGS. 15A and 15B represent the cross correlation coefficient between a reference sound field spectrum in the case where the entire space is filled with the air and a sound field spectrum in the case where the propane gas forms a globe, according to a frequency shift;

FIG. 16 shows a correlation coefficient not considering a frequency shift for the respective cases of FIGS. 12A to 15B;

FIG. 17 shows a frequency shift index for the respective cases of FIGS. 12A to 15B; and

FIG. 18 is a flowchart of a gas monitoring method that senses gas leak and mixing situations based on the correlation coefficient of sound field spectra according to an embodiment of the inventive concept.

### DETAILED DESCRIPTION

Embodiments of the inventive concept are described below with reference to the accompanying drawings so that a person skilled in the art may easily accomplish the technical spirit of the inventive concept.

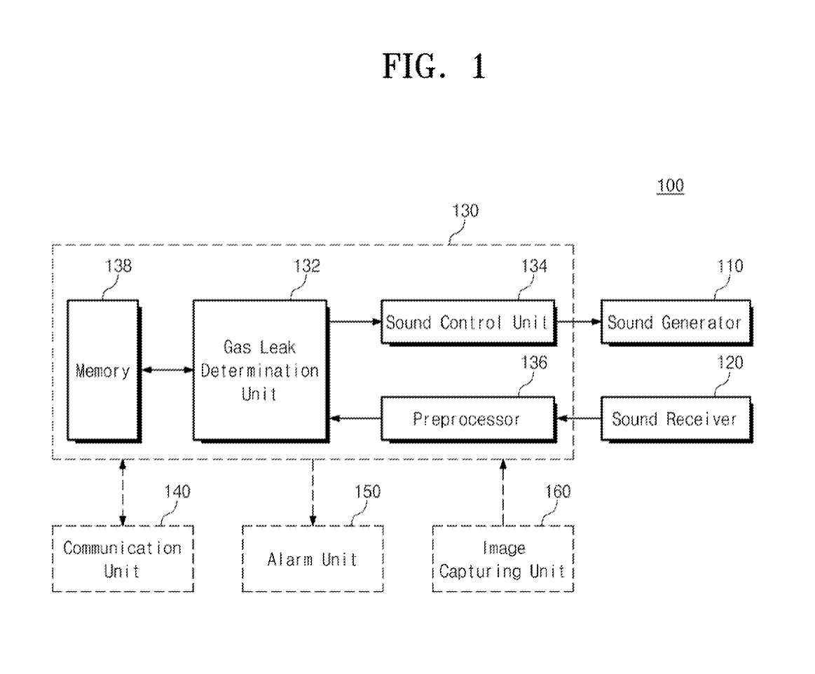

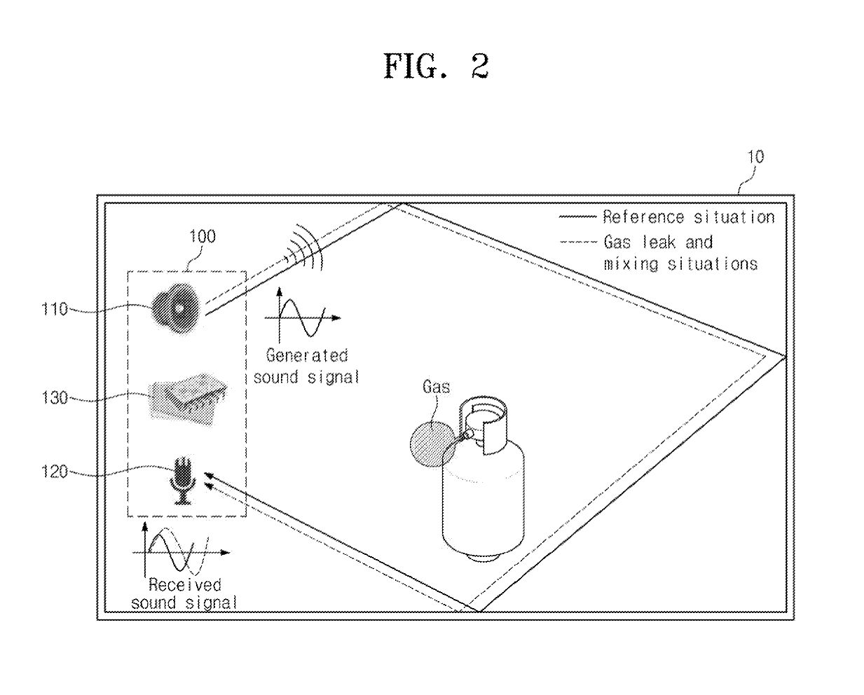

FIG. 1 is a block diagram of a gas monitoring apparatus according to an embodiment of the inventive concept. FIG. 2 is a conceptual view of a gas monitoring method using a gas monitoring apparatus according to an embodiment of the inventive concept. Referring to FIG. 1, a gas monitoring apparatus 100 may include a sound generator 110, a sound receiver 120, and a sound field signal processor 130. The sound field signal processor 130 may include a gas leak determination unit 132, a sound control unit 134, a pre-processor 136, and a memory 138. The gas monitoring apparatus 100 according to the inventive concept may further include a communication unit 140 for communication with an external device, an alarm unit 150 for alerting a gas leak, and an image capturing unit 160 for obtaining image information on a gas monitoring space.

In the following, the operation of the gas monitoring apparatus 100 according to an embodiment of the inventive concept is described in more detail with reference to FIGS. 1 and 2.

A gas monitoring space 10 may have various shapes and structures. As an example, the gas monitoring space 10 may include home, an office, a laboratory, a store, a warehouse, a factory, and a facility. Alternatively, the gas monitoring space may include a gas chamber or gas tank of any shape used for a process and operation. Gas leak and mixing may occur from any gas tank, pipe, or valve that is placed in the gas monitoring space.

It is significantly difficult to sense a gas leak that occurs in the spaces of various shapes as described above and at any position in the spaces. In order to prevent various accidents that include explosions, fires, injuries, and suffocation caused by such a gas leak, there is a need for a technology that senses gas leak and mixing that occur at any position in the gas monitoring space.

The gas to be sensed with respect to the leak and mixing may be a liquefied natural gas (LNG) that includes a methane gas, and a liquefied petroleum gas (LPG) that includes a propane gas and a butane gas that are generally used for heating and cooking. Also, the gas to be sensed with respect to the leak and mixing may be a combustible gas, such as a silane, ethane, hydrogen, acetylene, or ethylene gas. Also, the gas to be sensed with respect to the leak and mixing may be an assistant gas, such as an oxygen gas, a toxic gas, such as a phosphine, arsine, chlorine, or ammonia gas, and a gas that may cause suffocation, such as a nitrogen, carbon monoxide, carbon dioxide, argon, or helium gas. In addition to the above-described gases, the gas that the gas monitoring apparatus 100 according to the inventive concept may sense may include all gases that are used for various purposes in places, such as home, an office, a laboratory, a factory, a workroom, or a farm.

The sound generator 110 generates a sound wave, i.e., a sound signal according to the control of the sound control unit 134 of the sound field signal processor 130. The generated sound signal may be controlled according to the level of a voltage that the sound control unit 134 outputs. The sound generator 110 outputs the generated sound wave into the gas monitoring space. The sound generator 110 may be implemented in e.g., a speaker.

The sound generator 110 may output a sound wave according to an input voltage in the gas monitoring space. Here, the sound wave output from the sound generator may be a multi-tone sound wave that is formed by the linear sum of sine waves that have many frequency components in an audio frequency band of about 20 Hz to about 20 KHz and in an ultrasonic frequency band of about 20 KHz or higher. Here, the multi-tone sound wave may be a continuous wave or pulse wave.

The sound pressure of the sound generator 110 appears at the rated power of the gas monitoring apparatus 100 and may be set to the optimal amplitude at which it is possible to sense a variation in sound field according to gas leak and mixing situations.

The sound receiver 120 receives a sound wave that is detected inside the gas monitoring space. More particularly, the sound receiver 120 would receive the sound wave that is reflected from the inside of the monitoring space. The sound receiver 120 may obtain sound pressure from the received sound wave and obtain sound field information therefrom. Here, the sound receiver 120 may include a frequency conversion filter that converts the received sound wave into a frequency domain. The sound receiver 120 transmits the received sound wave to the preprocessor 136 of the sound field signal processor 130. The sound receiver 120 may be implemented in e.g., a microphone.

The sound field signal processor 130 may include the sound control unit 134, the pre-processor 136, the gas leak determination unit 132, and the memory 138.

The sound control unit 134 sets the sound pressure of the sound wave that is generated from the sound generator 110, and outputs the set sound wave through the sound generator 110.

The preprocessor 136 performed signal processing on the sound wave received by the sound receiver 120 to output the processed wave to the gas leak determination unit 132.

The memory 138 stores reference sound field spectrum information. The memory 138 may include a flash memory, a non-volatile memory, such as a PRAM, an MRAM, and an FRAM, and/or a volatile memory, such as a DRAM. As an embodiment, the memory 138 may be a memory card, such as an embedded multimedia card (eMMC).

The gas leak determination unit 132 may control the sound control unit 134, and use the sound signal received through the sound receiver 120 to sense a gas leak situation and the presence and absence of gas mixing.

The sound field signal processor 130 that includes the sound control unit 134, the preprocessor 136, the memory 138 as described above may use a variation in sound field spectrum of the gas monitoring space to sense the presence and absence of gas leak and mixing, and an amount of leak gas. The sound field signal processor 130 may be implemented through a smart device and a processor, such as a digital signal processor (DSP). A sound field value may be represented by sound pressure and a phase, and the sound pressure and phase may be used individually or combinedly. The gas monitoring apparatus 100 according to the inventive concept uses the sound pressure and a sound pressure level that is the amplitude of the sound pressure is used as a signal processing target. However, it is an example, and the gas monitoring apparatus 100 according to the inventive concept is not limited thereto. The sound pressure level may be typically represented by a log function. The sound pressure level may be a value obtained by measuring, by the sound receiver 120 according to the inventive concept, sound pressure in the gas monitoring space. Here, the sound pressure in the gas monitoring space is sound pressure appearing when the sound pressure output from the sound generator 110 is dispersed into the gas monitoring space.

Thus, the sound field signal processor 130 may use the sound pressure (P) of a sound in preparation mode to calculate reference sound pressure information (the amplitude (Amp=20 log P) of reference sound pressure) or the phase (Ph=ang (P)) of the reference sound pressure. In this case, the sound field signal processor 130 may measure a variation pattern of a sound field spectrum according to time in order to solve a malfunction issues caused by a variation in the sound pressure (P) due to an environmental variation, such as gradual variations in temperature and humidity of the air. The sound field signal processor 130 may analyze the measured variation pattern of the sound field spectrum according to time to set an initialization time period of the reference sound field and a reference value for determining a gas sensing situation.

In addition, the sound field signal processor 130 may use a sound transfer function (P′) in a monitoring mode to calculate current sound pressure information (amplitude (Amp=20 log (P′) of the current sound pressure) or the phase (Ph=ang (P′)) of the current sound pressure, and then compare the reference sound pressure information with the current sound pressure information to determine whether gas leak and mixing situations occur.

More particularly, the sound field signal processor 130 may determine that the gas leak and mixing situations have occurred, through the following embodiments.

The gas monitoring apparatus 100 according to an embodiment of the inventive concept may analyze a variation pattern in sound field spectrum according to a frequency of a multi-tone sound source, and use a correlation, such as the correlation coefficient between sound field spectra to determine the presence and absence of gas leak and mixing. The multi-tone sound source used for sound field measurement has a central frequency of e.g., about 4 kHz, a frequency interval of about 4 Hz, and a total of 17 channel frequencies. The sound generator 110 may generate a sound source for about 0.5 sec. The sound receiver 120 receives the generated sound signal. The sound field signal processor 130 may frequency-filter the sound signal to obtain a sound field spectrum. Typically, the sound field spectrum has little variation before a gas is leaked or mixed. However, if the gas is leaked or mixed, a condition varies by the physical property of the gas and the sound field spectrum may thus vary.

As an example, the speed of a sound wave may vary by the gas leak or mixing in the gas monitoring space and its wavelength at the same frequency may thus increase proportionally. Since the size of the monitoring space is fixed, the wavelength of a sound wave need to be constant to enable the sound receiver 120 to receive a sound wave having the same sound pressure in the case where the speed of a sound wave varies. Thus, a variation pattern in the sound field spectrum moves toward the high frequency or low frequency without a variation in shape. In this case, the variation value δf of a shift frequency may be expressed by Equation 1 below:

δf=f*δv/v (1)

Where f is the frequency of a sound wave, v is the speed of the sound wave, and δv is the speed variation value of the sound wave.

A cross correlation coefficient that is obtained by using the frequency shift between the reference sound field spectrum and a sound field spectrum continuously measured after it as a variable may be expressed by Equation 2 below:

$${R}_{i , j} ( m ) = \frac{{\sum }_{n = 1}^{N - m} ( {S}_{j} ( n + m ) - mean ( {S}_{j} ) ) ( {S}_{i} ( n ) - mean ( {S}_{i} ) )}{\sqrt{{\sum }_{n = 1}^{N} {( {S}_{i} ( n ) - mean ( {S}_{i} ) )}^{2}} \sqrt{{\sum }_{n = 1}^{N} {( {S}_{j} ( n ) - mean ( {S}_{j} ) )}^{2}}} m \geq 0 , \\ {R}_{i , j} ( m ) = {R}_{j , i} ( - m ) , m < 0 \qquad ( 2 )$$

where R_{i,j} denotes a cross correlation coefficient between an ith measured sound field Sᵢ, and jth measured sound field Sⱼ, N denotes the number of channels of a multi-tone sound source, and m denotes a neighboring frequency interval of the multi-tone sound source as a unit of frequency shift value.

In particular, in the case where m=0, the cross correlation coefficient is a result of dividing a covariance value of two sound field spectra without frequency shift by a multiplication of standard deviation values of ith and jth measured sound field spectra. Also, in the case where m is not 0, the cross correlation coefficient is a result of dividing, a covariance value of an ith sound field spectrum and a jth sound field spectrum that has shifted by m in frequency, by a multiplication of standard deviation values of ith and jth measured sound field spectra.

By analyzing a variation in the cross correlation coefficient, it is possible to quantize a variation in the sound field spectrum by gas leak or mixing. Also, it is possible to sense an amount of leak gas from a variation pattern, such as a frequency shift.

The gas leak and mixing monitoring apparatus 100 according to the inventive concept may further include the communication unit 140, the alarm unit 150, and the image capturing unit 160.

The communication unit 140 may communicate with the outside of the gas monitoring apparatus 100 according to a wired or wireless communication protocol. As an example, the communication unit 140 may communicate with the outside of the gas monitoring apparatus 100 according to at least one of various wireless communication protocols, such as WiMax, GSM, CDMA, W-CDMA, LTE, Bluetooth, NFC, WiFi, and RFID, or various wired communication protocols, such as universal serial bus (USB), small computer system interface (SCSI), peripheral component interconnect (PCI) Express, advanced technology attachment (ATA), parallel ATA (PATA), serial ATA (SATA), serial attached SCSI (SAS), integrated drive electronics (IDE), and Firewire.

The alarm unit 150 may alert the user through a sound and/or light in the case the gas leak determination unit 132 determines as gas leak and mixing situations. As an example, the alarm unit 150 may include a speaker and/or LED devices.

The image capturing unit 160 may capture images inside the gas monitoring space to obtain image information. As an example, the image capturing unit 160 may capture images in the gas monitoring space in the case where it is sensed that gas leak and mixing situations have occurred.

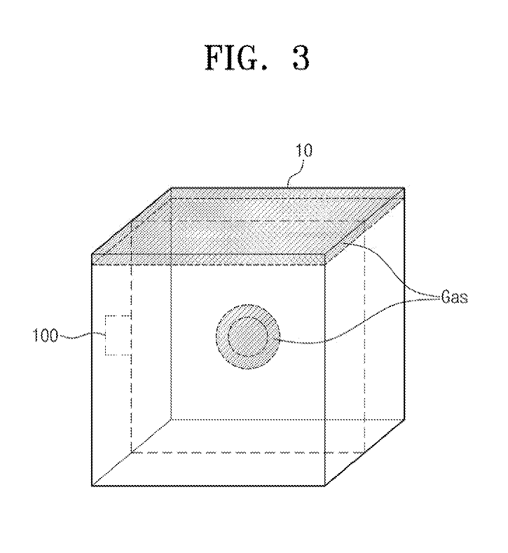

FIG. 3 shows a situation in which gas leak and mixing occur in a cube-shape gas monitoring space. More particularly, FIG. 3 shows the case where a gas is leaked in a globe shape at the center of a 60 cm long cube-shape gas monitoring space and the case where a gas forms a layer on one surface of the cube. For simulation, it is assumed that the reference situation is a situation in which the monitoring space is filled with 1 atmosphere air. The reference situation may also be generally applied to a situation in which the space is uniformly filled with a single gas or various types of gases. Finite element analysis has been performed using COMSOL and regarding the physical properties of the used air at a temperature of about 20 degrees, the density of the air is about 1.205 kg/m³ and the speed of a sound wave is about 343.5 m/sec.

The gases leaked through the simulation are a methane gas (CH₄) that is the main component of an LNG gas and a propane gas (C₃H₈) that is the main component of an LPG gas, and regarding physical properties used for the finite element analysis at a temperature of about 20 degrees, in the case of the methane gas, its density is about 0.75 kg/m³ and the speed of a sound wave is about 446 m/sec, and in the case of the propane gas, its density is about 1.82 kg/m³ and the speed of a sound wave is about 258 m/sec. If the gas is leaked, it is generally mixed with the air in the actual situation, but for the convenience of simulation, a situation is assumed in which the methane gas and the propane gas fill the space in a globe shape having a diameter of about 16 cm and about 20 cm.

Since the methane gas is lower than the air in density, the leaked gas rises inside the monitoring space and forms a layer on the upper part thereof after a certain time. On the contrary, since the propane gas is higher than the air in density, the leaked gas falls inside the monitoring space and forms a layer on the lower part thereof after a certain time. However, in the two cases, a layer would be formed on one surface of the cube. Thus, in order to approximately simulate the situation, a situation in which a gas forms a layer on one surface of the cube as shown in FIG. 3 is simulated by finite element analysis and is compared with the case where the gas forms a globe at the center. A simulation result for the finite element analysis on about 0.6 cm wide and about 1.2 cm wide gas layers that have substantially the same volume as globes having diameters of about 16 cm and about 20 cm is compared so that an amount of the exposed gas is constant even when shapes are different from each other. In the simulation, the boundary condition of the sound generator 110 is set to about 10 m/sec² in acceleration of a sound thin film towards the inside of a box. The sound pressure level in the entire gas monitoring space is calculated at an interval of about 1 Hz for a sound frequency band of about 950 Hz to about 1050 Hz, and a sound pressure level for each frequency at the sound receiver 120 that is 3.5 cm away from the sound generator 110 is calculated.

The gas for monitoring a leak may be a methane, propane or butane gas that that forms LNG and LPG, or a combustible gas, such as a silane, ethane, hydrogen, acetylene, or ethylene gas. Alternatively, the gas for monitoring the leak may be an assistant gas, such as an oxygen gas, or a toxic gas, such as a phosphine, arsine, or ammonia gas. Alternatively, the gas for monitoring the leak may be a gas that may cause suffocation, such as a nitrogen, carbon monoxide, carbon dioxide, argon, or helium gas. However, the gas monitoring apparatus 100 according to the inventive concept may monitor the leak of all gases that are used for various purposes in places, such as home, an office, a factory, a workroom, and a farm without a limitation to the above-described gases. Although the present disclosure describes a gas monitoring method based on a variation in sound field using methane and propane gases as an example, types of gases applied to the inventive concept are not limited thereto.

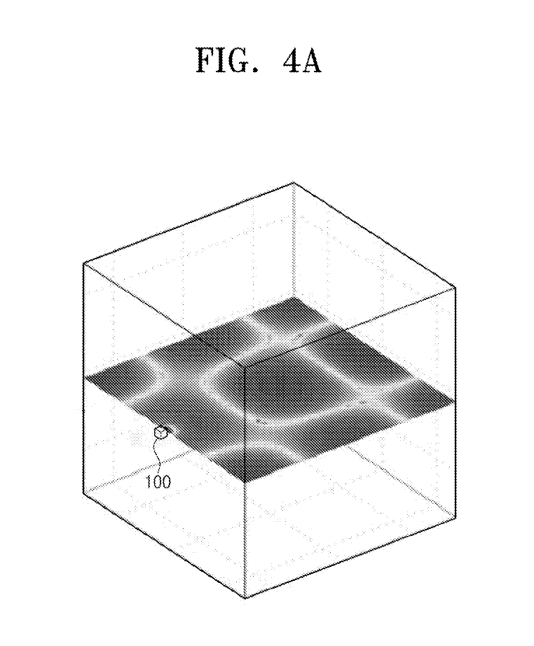

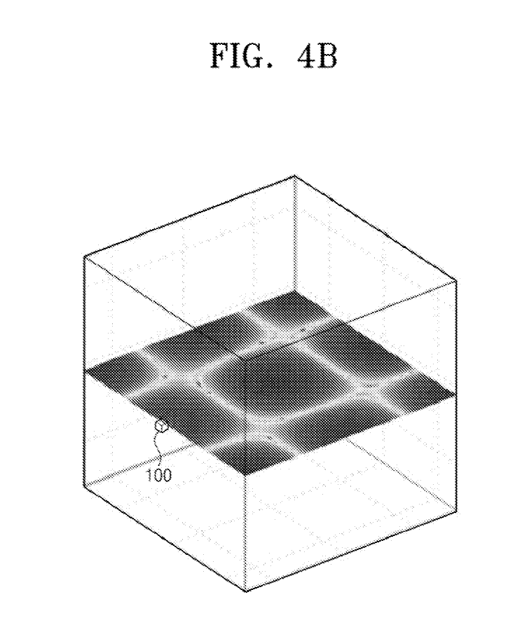

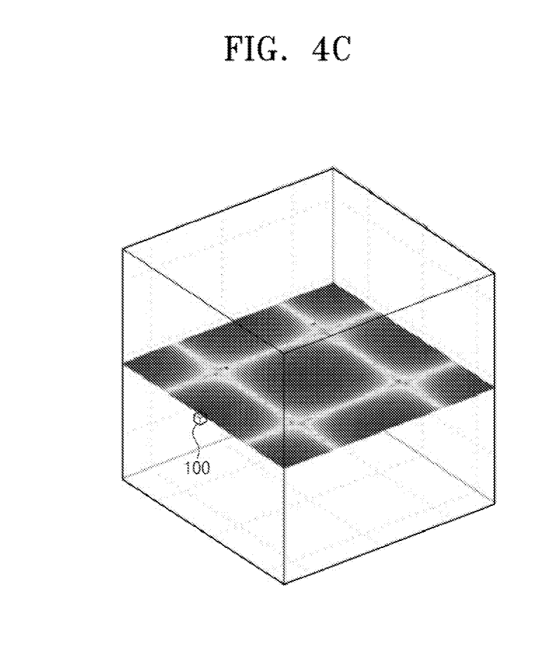

FIGS. 4A to 4C show a result of simulation on a sound pressure level using finite element analysis in the case where a methane gas forms a layer in the gas monitoring space in FIG. 2. More particularly, FIG. 4A shows a result of infinite element analysis simulation in the case where the entire gas monitoring space is air, FIG. 4B shows a result of infinite element analysis simulation in the case where one surface of the gas monitoring space forms an about 0.6 cm thick methane gas layer, and FIG. 4C shows a result of infinite element analysis simulation in the case where one surface of the gas monitoring space forms an about 1.2 cm thick methane gas layer.

Referring to FIGS. 4A to 4C, it may be seen that the patterns of sound pressure levels at the square cross-section in the middle of the gas monitoring space are different from one another due to the methane gas.

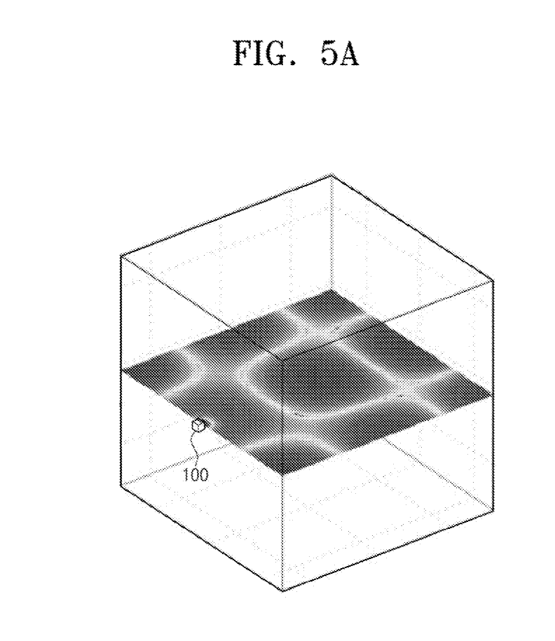

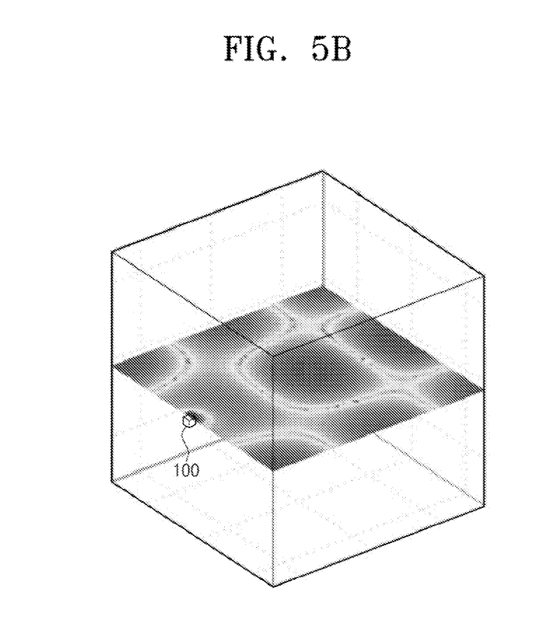

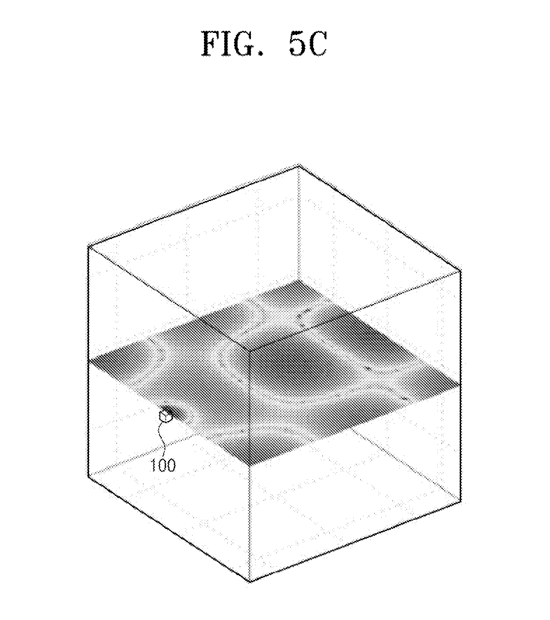

FIGS. 5A to 5C show a result of simulation on a sound pressure level using finite element analysis in the case where a propane gas forms a layer in the gas monitoring space in FIG. 2. More particularly, FIG. 5A shows a result of infinite element analysis simulation in the case where the entire gas monitoring space is air, FIG. 5B shows a result of infinite element analysis simulation in the case where one surface of the gas monitoring space forms an about 0.6 cm thick propane gas layer, and FIG. 5C shows a result of infinite element analysis simulation in the case where one surface of the gas monitoring space forms an about 1.2 cm thick propane gas layer.

Referring to FIGS. 5A to 5C, it may be seen that the patterns of sound pressure levels at the square cross-section in the middle of the gas monitoring space are different from one another due to the propane gas. Also, it may be seen that the patterns are also different from the patterns of the sound pressure levels in FIGS. 4A to 4C in which the methane gas forms a layer.

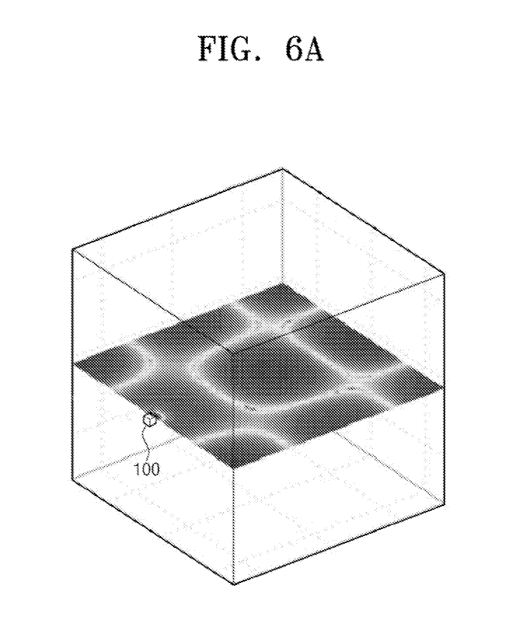

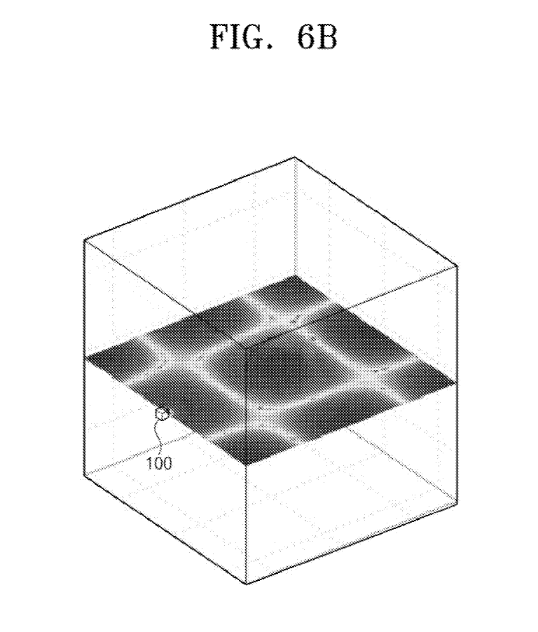

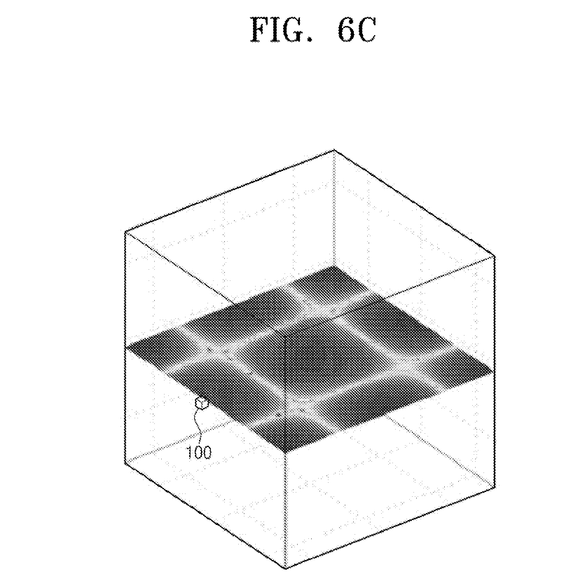

FIGS. 6A to 6C show a result of simulation on a sound pressure level using finite element analysis in the case where a methane gas exists in a globe shape in the gas monitoring space in FIG. 2. More particularly. FIG. 6A shows a result of infinite element analysis simulation in the case where the entire gas monitoring space is air, FIG. 6B shows a result of infinite element analysis simulation in the case where a globe-shape methane gas having a diameter of about 16 cm exists at the center of the gas monitoring space, and FIG. 6C shows a result of infinite element analysis simulation in the case where a globe-shape methane gas having a diameter of about 20 cm exists at the center of the gas monitoring space.

Referring to FIGS. 6A to 6C, it may be seen that the sound pressure levels at the square cross-section in the middle of the gas monitoring space have a variation pattern similar to FIGS. 4A to 4C that are different in distribution shape of a gas but similar in volume.

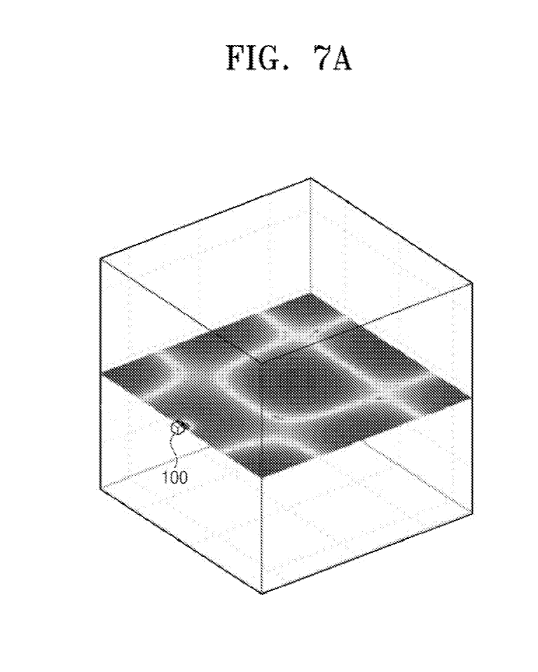

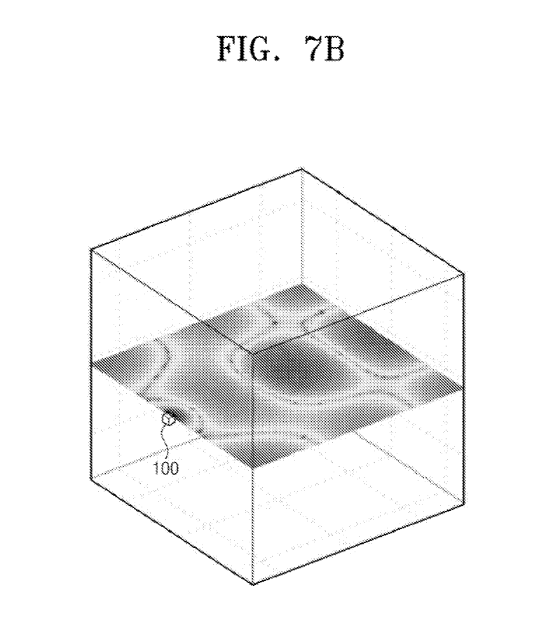

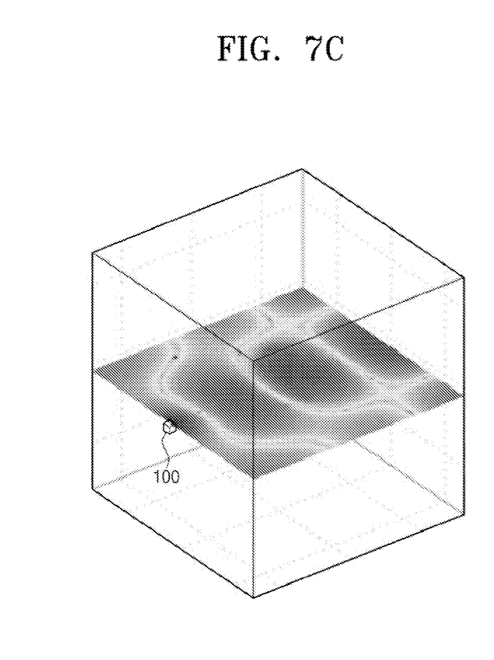

FIGS. 7A to 7C show a result of simulation on a sound pressure level using finite element analysis in the case where a propane gas exists in a globe shape in the gas monitoring space in FIG. 2. More particularly, FIG. 7A shows a result of infinite element analysis simulation in the case where the entire gas monitoring space is air, FIG. 7B shows a result of infinite element analysis simulation in the case where a globe-shape propane gas having a diameter of about 16 cm exists at the center of the gas monitoring space, and FIG. 7C shows a result of infinite element analysis simulation in the case where a globe-shape propane gas having a diameter of about 20 cm exists at the center of the gas monitoring space.

Referring to FIGS. 7A to 7C, it may be seen that the sound pressure levels at the square cross-section in the middle of the gas monitoring space have a variation pattern similar to FIGS. 5A to 5C that are different in distribution shape of a gas but similar in volume.

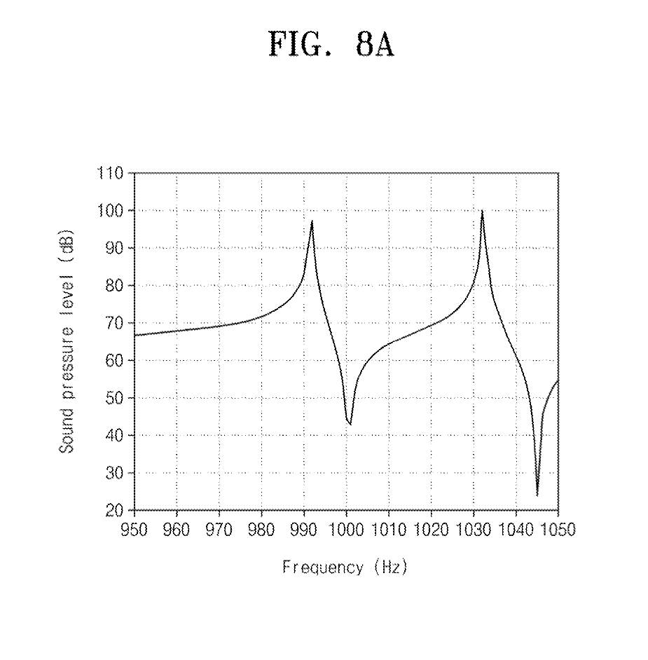

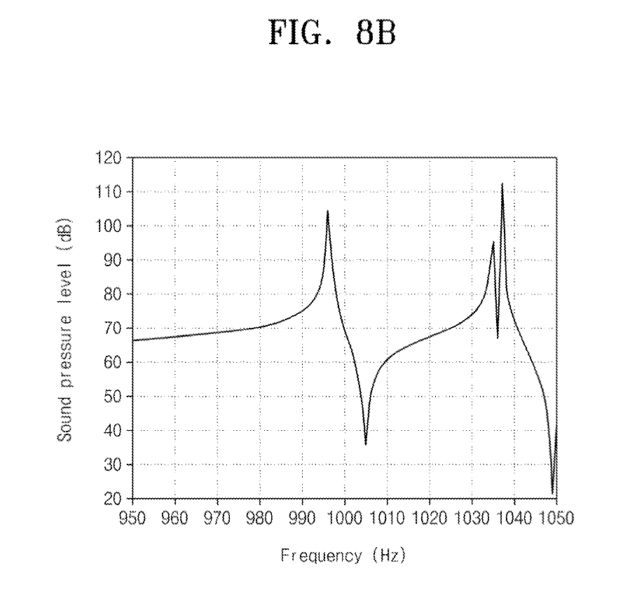

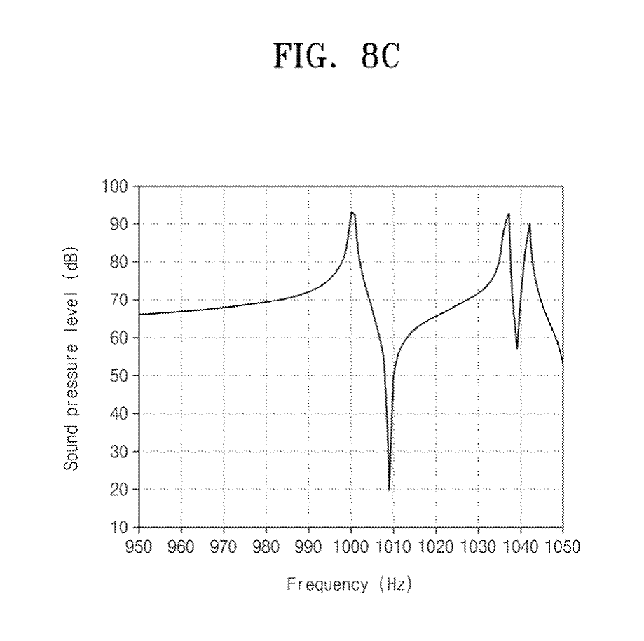

FIGS. 8A to 8C show sound field spectra calculated by the gas monitoring apparatus according to the inventive concept in the cases of FIGS. 4A to 4C. FIG. 8A shows a sound field spectrum according to a sound frequency at the position of the sound receiver 120 as a result of infinite element analysis simulation in the case where the entire gas monitoring space is air, FIG. 8B shows a sound field spectrum according to a sound frequency at the position of the sound receiver 120 as a result of infinite element analysis simulation in the case where one surface of the gas monitoring space forms an about 0.6 cm thick methane gas layer, and FIG. 8C shows a sound field spectrum according to a sound frequency at the position of the sound receiver 120 as a result of infinite element analysis simulation in the case where one surface of the gas monitoring space forms an about 1.2 cm thick methane gas layer.

Referring to FIGS. 8A to 8C, it may be seen that with a methane gas leak, the positions of the peak and dip of a spectrum move toward the high frequency and its shape varies. A phenomenon that the right peak is divided into two parts appears especially in FIGS. 8B and 8C, but a phenomenon that on the whole, a moving level increases with an increase in thickness of methane gas appears. This phenomenon appears because the speed of a sound wave in the methane gas space increases, and it is not completely the same as the case where the methane gas is slowly mixed in the entire space and be roughly represented in such a manner that a frequency shifts according to Equation 1.

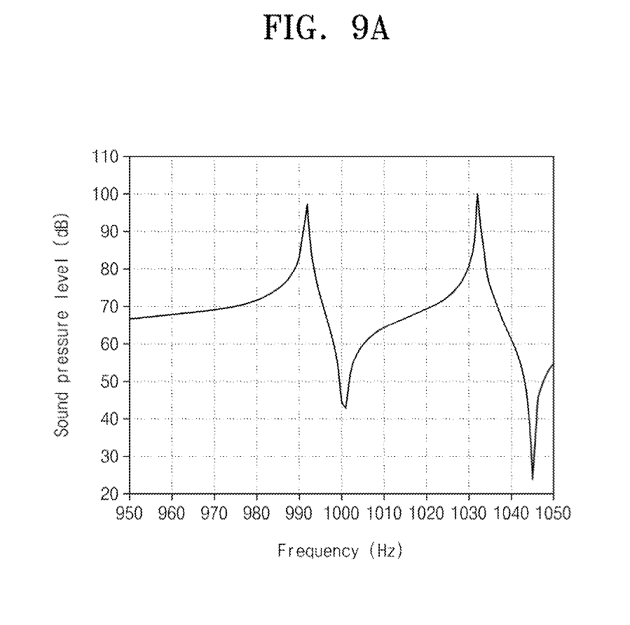

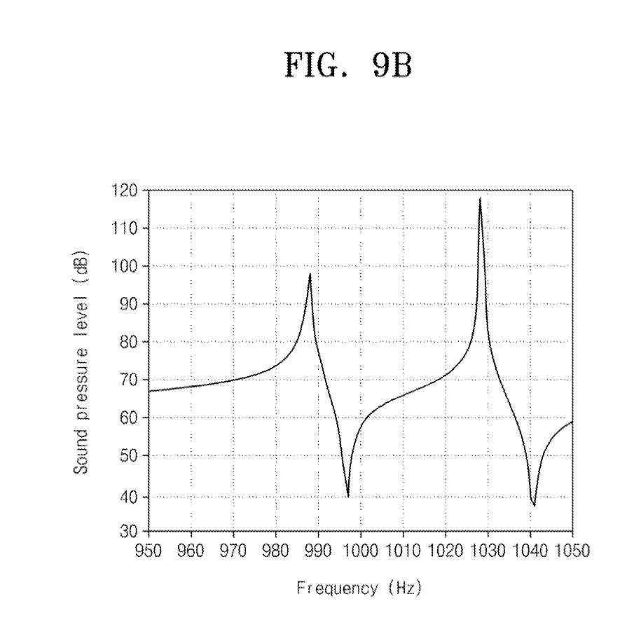

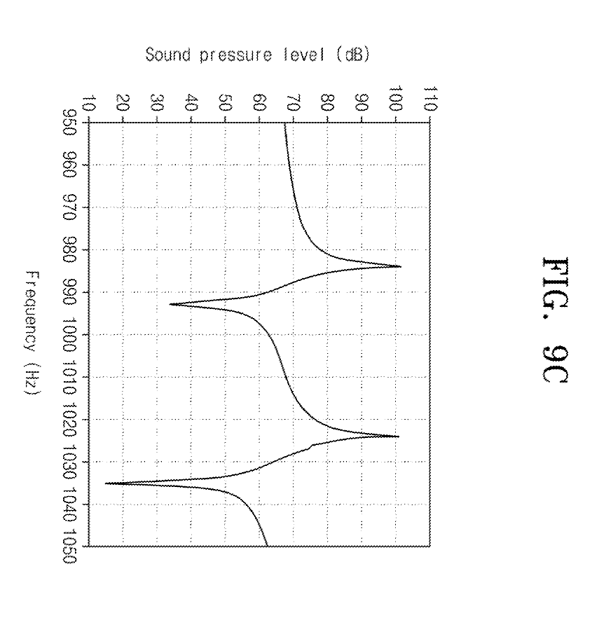

FIGS. 9A to 9C show sound field spectra calculated by the gas monitoring apparatus according to the inventive concept in the cases of FIGS. 5A to 5C. FIG. 9A shows a sound field spectrum according to a sound frequency at the position of the sound receiver 120 as a result of infinite element analysis simulation in the case where the entire gas monitoring space is air, FIG. 9B shows a sound field spectrum according to a sound frequency at the position of the sound receiver 120 as a result of infinite element analysis simulation in the case where one surface of the gas monitoring space forms an about 0.6 cm thick propane gas layer, and FIG. 9C shows a sound field spectrum according to a sound frequency at the position of the sound receiver 120 as a result of infinite element analysis simulation in the case where one surface of the gas monitoring space forms an about 1.2 cm thick propane gas layer.

Referring to FIGS. 9A to 9C, it may be seen that with a propane gas leak, the positions of the peak and dip of a spectrum move toward the low frequency. In this case, the right peak is not especially divided into two parts and a phenomenon that on the whole, a level moving toward the low frequency increases with an increase in thickness of propane gas appears. This phenomenon appears because the speed of a sound wave in the propane gas space decreases, and it is not completely the same as the case where the propane gas is slowly mixed in the entire space. However, a phenomenon that a frequency shifts approximately according to Equation 1 may appear.

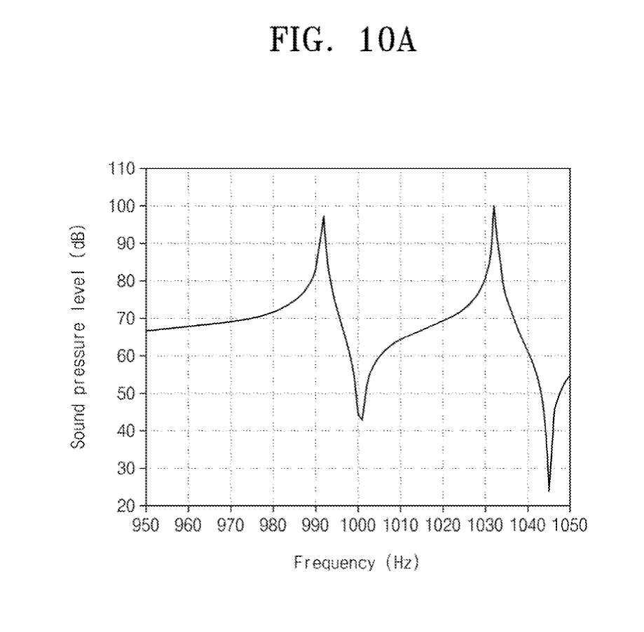

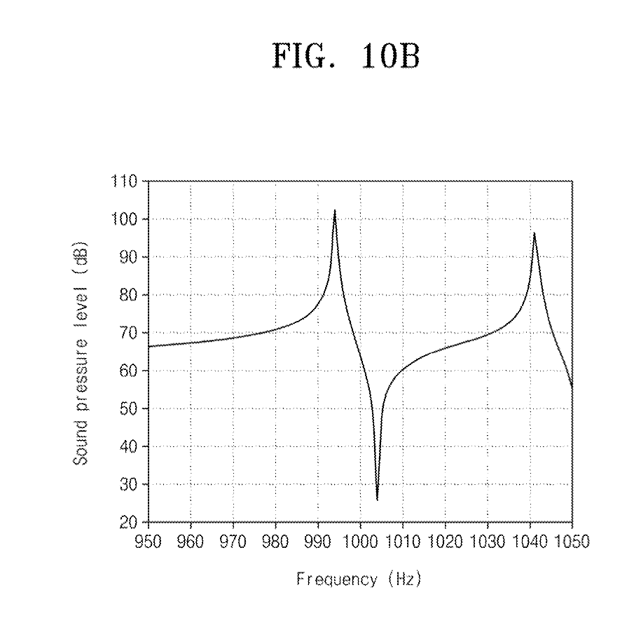

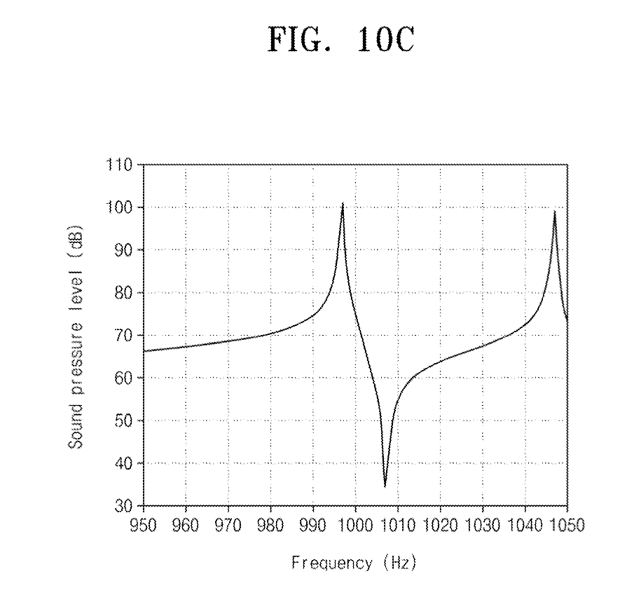

FIGS. 10A to 10C show sound field spectra calculated by the gas monitoring apparatus according to the inventive concept in the cases of FIGS. 6A to 6C. FIG. 10A shows a sound field spectrum according to a sound frequency at the position of the sound receiver 120 as a result of infinite element analysis simulation in the case where the entire gas monitoring space is air, FIG. 10B shows a sound field spectrum according to a sound frequency at the position of the sound receiver 120 as a result of infinite element analysis simulation in the case where a globe-shape methane gas having a diameter of about 16 cm exists at the center of the gas monitoring space, and FIG. 10C shows a sound field spectrum according to a sound frequency at the position of the sound receiver 120 as a result of infinite element analysis simulation in the case where a globe-shape methane gas having a diameter of about 20 cm exists at the center of the gas monitoring space.

Referring to FIGS. 10A to 10C, it may be seen that with a methane gas leak, the positions of the peak and dip of a spectrum move toward the high frequency as well. In this case, a phenomenon that the right peak is divided into two parts does not appear and a phenomenon that on the whole, a moving level increases with an increase in volume of methane gas appears. This phenomenon appears because the speed of a sound wave in the methane gas space increases, it is not completely the same as the case where the methane gas is slowly mixed in the entire space, and a phenomenon that a frequency shifts according to roughly Equation 1 may appear.

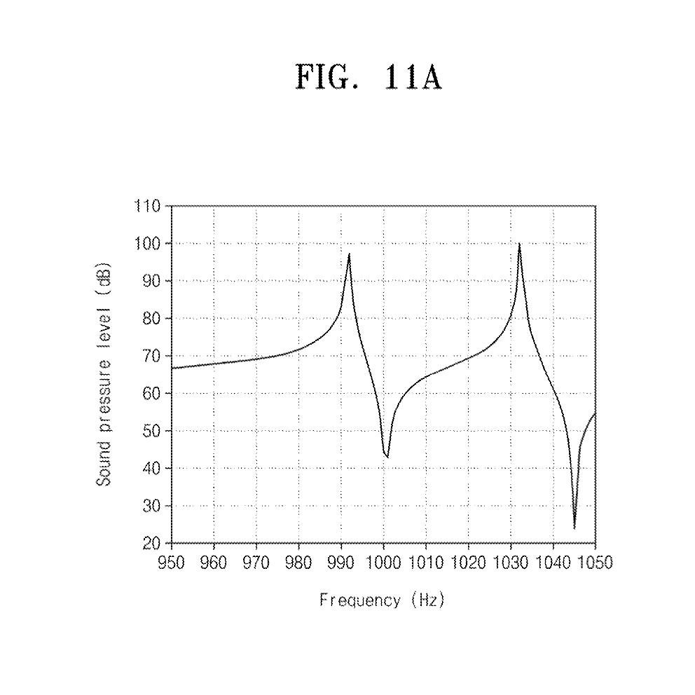

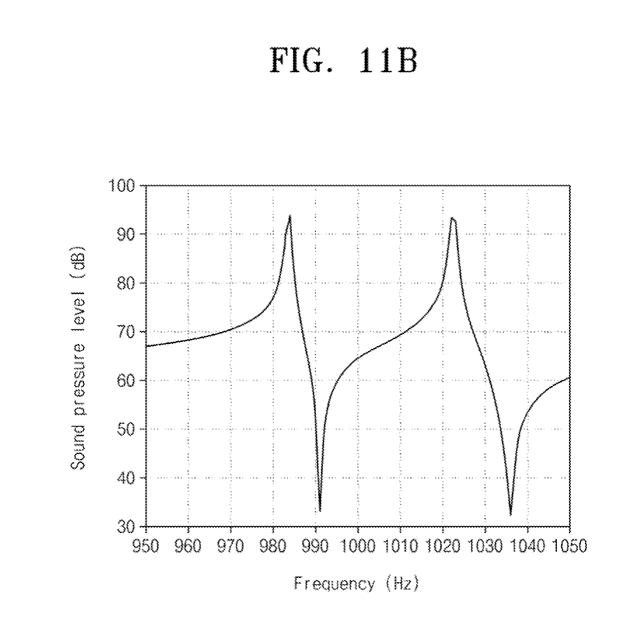

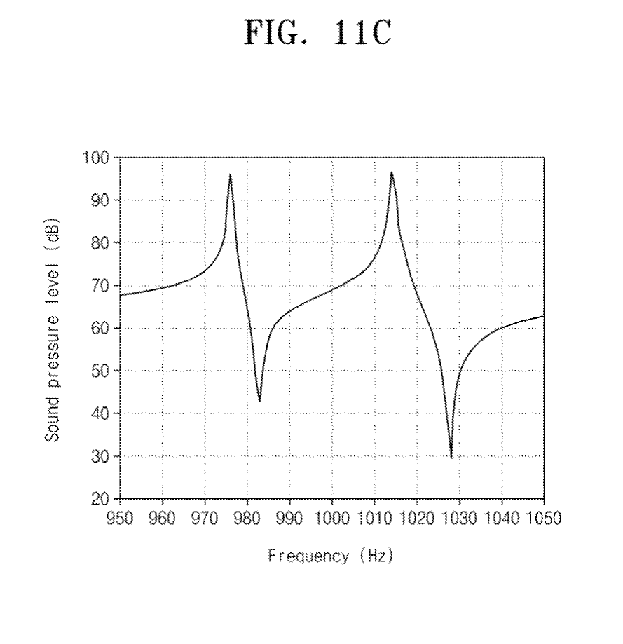

FIGS. 11A to 11C show sound field spectra calculated by the gas monitoring apparatus according to the inventive concept in the cases of FIGS. 7A to 7C. FIG. 11A shows a sound field spectrum according to a sound frequency at the position of the sound receiver 120 as a result of infinite element analysis simulation in the case where the entire gas monitoring space is air, FIG. 11B shows a sound field spectrum according to a sound frequency at the position of the sound receiver 120 as a result of infinite element analysis simulation in the case where a globe-shape propane gas having a diameter of about 16 cm exists at the center of the gas monitoring space, and FIG. 11C shows a sound field spectrum according to a sound frequency at the position of the sound receiver 120 as a result of infinite element analysis simulation in the case where a globe-shape propane gas having a diameter of about 20 cm exists at the center of the gas monitoring space.

Referring to FIGS. 11A to 11C, it may be seen that with a propane gas leak, the positions of the peak and dip of a spectrum move toward the low frequency. In this case, the right peak is not divided into two parts and a phenomenon that on the whole, a level moving toward the low frequency increases with an increase in volume of propane gas appears. This phenomenon appears because the speed of a sound wave in the propane gas space decreases, it is not completely the same as the case where the propane gas is slowly mixed in the entire space, a phenomenon that a frequency shifts according to Equation 1 may appear.

Although only two typical cases are compared, it may be seen that a trend that the pattern of a sound field spectrum is similar but only a frequency shifts toward the high frequency or toward the low frequency equally appears in the case where a methane or propane gas has the same volume in a cube. If the variation pattern of a sound field spectrum is analyzed by using such a phenomenon when different kinds of gases are leaked or mixed, it is possible to monitor whether a gas leak occurs and an amount of leak gas.

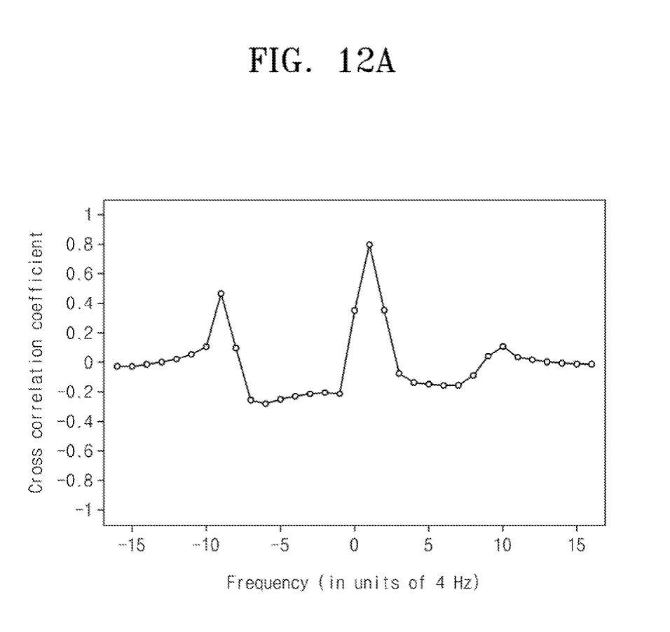

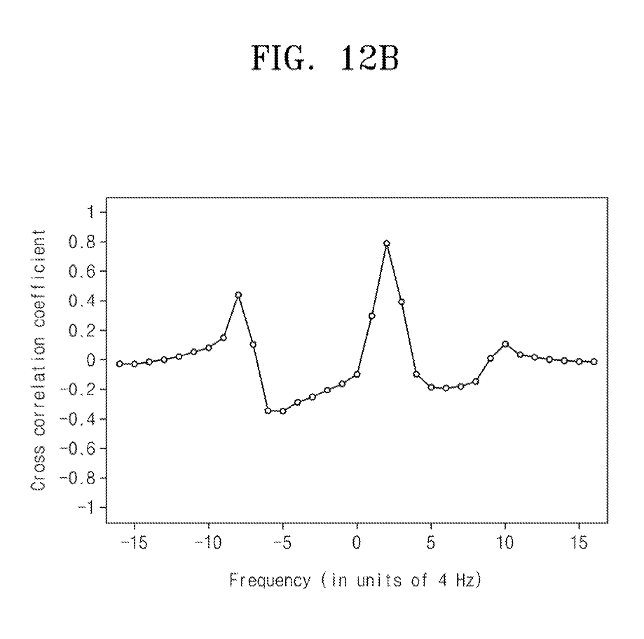

FIGS. 12A to 15B show the correlation coefficient between a reference sound field spectrum in the case where the entire space is filled with the air and a sound field spectrum in the case where the space is partially filled with different kinds of gases in order to analyze the variation pattern of a sound field spectrum. In this case, Equation 2 above is used as an expression to find the correlation coefficient. A frequency of a multi-tone sound source used to find the correlation coefficient is set to 17 channels, its central frequency is set to about 4 kHz, an interval between frequencies is set to about 4 Hz, and the x axis on the graph is a frequency shift index in units of about 4 Hz.

FIGS. 12A and 12B represent the cross correlation coefficient between a reference sound field spectrum in the case where the entire space is filled with the air and a sound field spectrum in the case where the methane gas forms a layer, according to a frequency shift. FIG. 12A represents he cross correlation coefficient between a reference sound field spectrum in the case the entire space is filled with the air and a sound field spectrum in the case where one surface is an about 0.6 cm thick methane layer, according to a frequency shift. FIG. 12B represents he cross correlation coefficient between a reference sound field spectrum in the case the entire space is filled with the air and a sound field spectrum in the case where one surface is an about 1.2 cm thick methane layer, according to a frequency shift.

Referring to FIG. 12A, it may be seen that the maximum value of the cross correlation coefficient in the case where the thickness of the methane gas is about 0.6 cm is about 0.8, in which case a frequency shift index is about 1 and the correlation coefficient not considering a frequency shift is about 0.35. Referring to FIG. 12B, it may be seen that the maximum value of the cross correlation coefficient in the case where the thickness of the methane gas is about 1.2 cm is about 0.79, in which case a frequency shift index is about 2 and the correlation coefficient not considering a frequency shift is about −0.09.

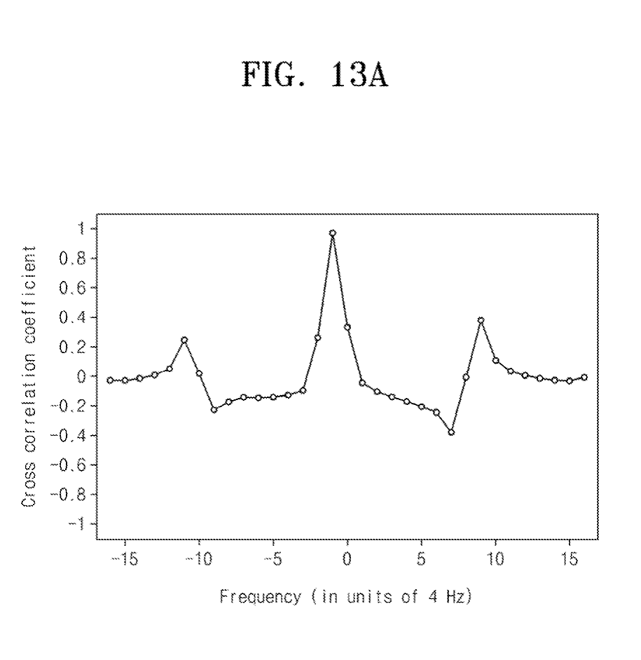

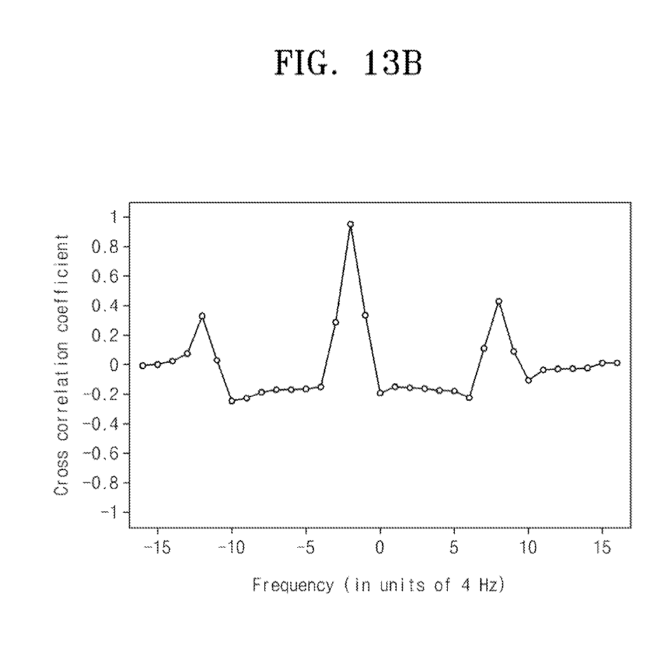

FIGS. 13A and 13B represent the cross correlation coefficient between a reference sound field spectrum in the case where the entire space is filled with the air and a sound field spectrum in the case where a propane gas forms a layer, according to a frequency shift. FIG. 13A represents the cross correlation coefficient between a reference sound field spectrum in the case the entire space is filled with the air and a sound field spectrum in the case where one surface is an about 0.6 cm thick propane layer, according to a frequency shift. FIG. 13B represents the cross correlation coefficient between a reference sound field spectrum in the case the entire space is filled with the air and a sound field spectrum in the case where one surface is an about 1.2 cm thick propane layer, according to a frequency shift.

Referring to FIG. 13A, it may be seen that the maximum value of the cross correlation coefficient in the case where the thickness of the propane gas is about 0.6 cm is about 0.97, in which case a frequency shift index is about −1 and the correlation coefficient not considering a frequency shift is about 0.33. Referring to FIG. 13B, it may be seen that the maximum value of the cross correlation coefficient in the case where the thickness of the propane gas is about 1.2 cm is about 0.96, in which case a frequency shift index is about −2 and the correlation coefficient not considering a frequency shift is about −0.19.

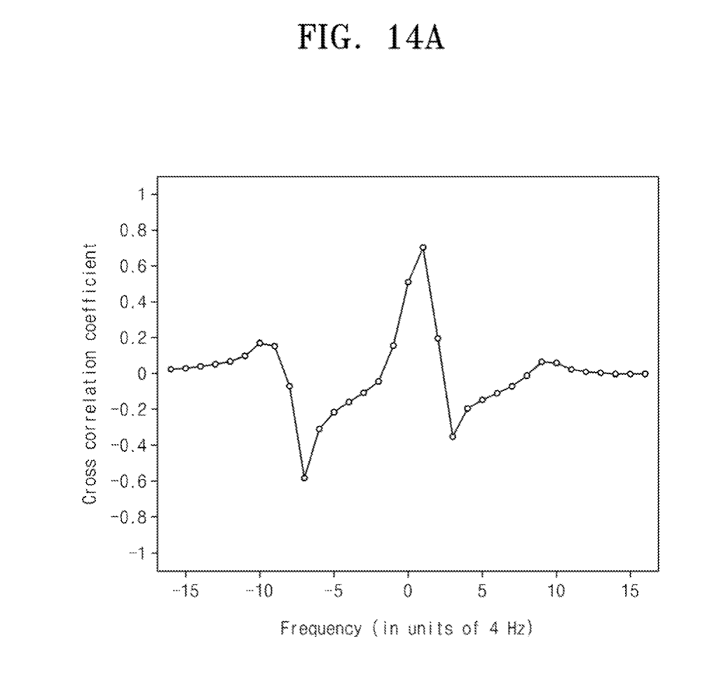

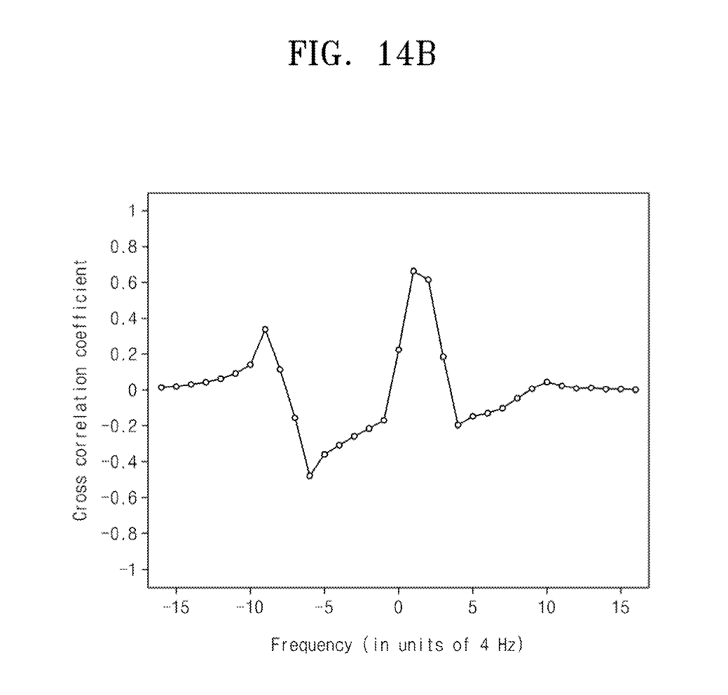

FIGS. 14A and 14B represent the cross correlation coefficient between a reference sound field spectrum in the case where the entire space is filled with the air and a sound field spectrum in the case where a methane gas forms a globe, according to a frequency shift. FIG. 14A represents the cross correlation coefficient between a reference sound field spectrum in the case the entire space is filled with the air and a sound field spectrum in the case where the methane gas has a globe shape having a diameter of about 16 cm, according to a frequency shift. FIG. 14B represents the cross correlation coefficient between a reference sound field spectrum in the case the entire space is filled with the air and a sound field spectrum in the case where the methane gas has a globe shape having a diameter of about 20 cm, according to a frequency shift.

Referring to FIG. 14A, it may be seen that the maximum value of the cross correlation coefficient in the case where the methane gas has the globe shape having a diameter of about 16 cm is about 0.71, in which case a frequency shift index is about 1 and the correlation coefficient not considering a frequency shift is about 0.51. Referring to FIG. 14B, it may be seen that the maximum value of the cross correlation coefficient in the case where the methane gas has the globe shape having a diameter of about 20 cm is about 0.66, in which case a frequency shift index is about 1 and the correlation coefficient not considering a frequency shift is about 0.22.

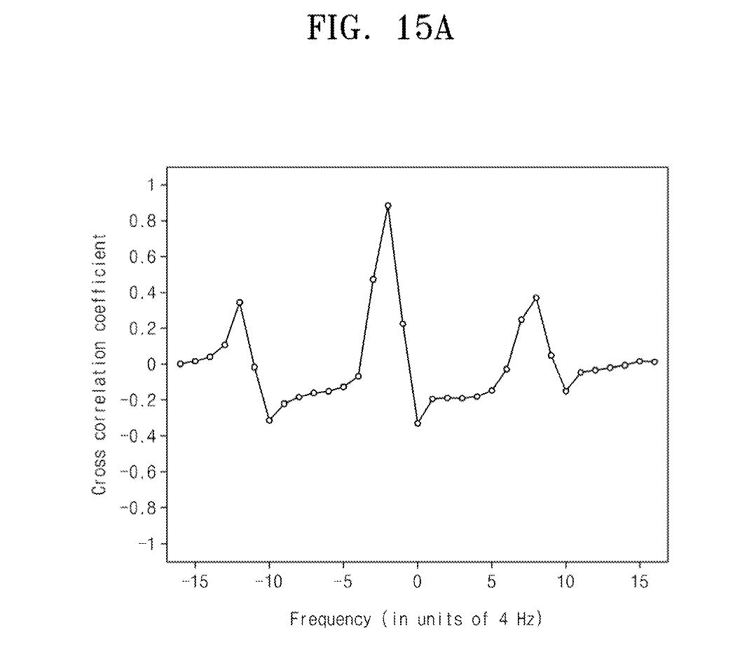

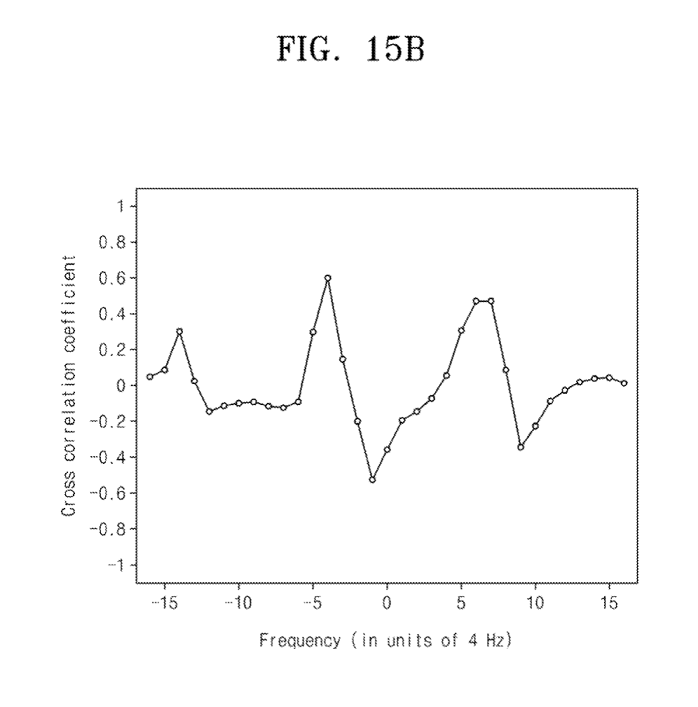

FIGS. 15A and 15B represent the cross correlation coefficient between a reference sound field spectrum in the case where the entire space is filled with the air and a sound field spectrum in the case where a propane gas forms a globe, according to a frequency shift. FIG. 15A represents he cross correlation coefficient between a reference sound field spectrum in the case the entire space is filled with the air and a sound field spectrum in the case where the propane gas has a globe shape having a diameter of about 16 cm, according to a frequency shift. FIG. 15B represents the cross correlation coefficient between a reference sound field spectrum in the case the entire space is filled with the air and a sound field spectrum in the case where the propane gas has a globe shape having a diameter of about 20 cm, according to a frequency shift.

Referring to FIG. 15A, it may be seen that the maximum value of the cross correlation coefficient in the case where the propane gas has the globe shape having a diameter of about 16 cm is about 0.89, in which case a frequency shift index is about −2 and the correlation coefficient not considering a frequency shift is about −0.33. Referring to FIG. 15B, it may be seen that the maximum value of the cross correlation coefficient in the case where the propane gas has the globe shape having a diameter of about 20 cm is about 0.59, in which case a frequency shift index is about −4 and the correlation coefficient not considering a frequency shift is about −0.36.

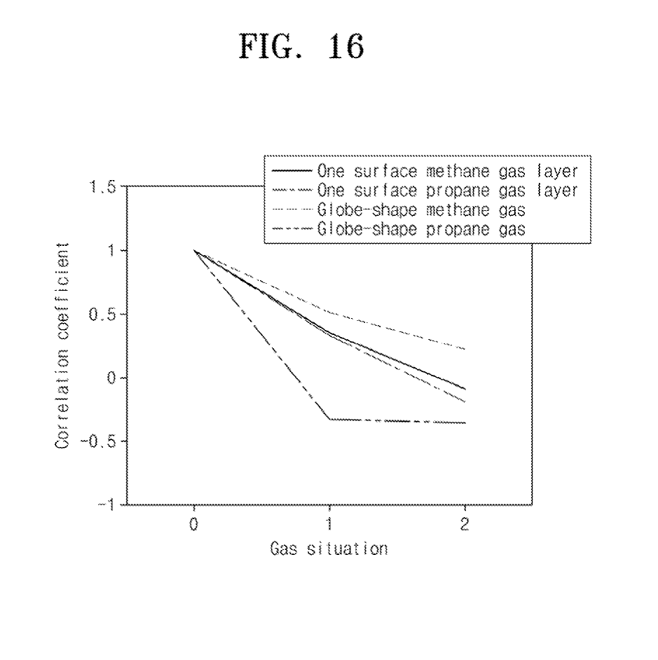

FIG. 16 shows a correlation coefficient not considering a frequency shift for the respective cases of FIGS. 12A to 15B.

Gas situation 1 shows a situation in which methane and propane gases are leaked with an about 0.6 cm thick layer and a globe having an about 16 cm, in which case the volumes of leaked cases are similar to each other, and gas situation 2 shows a situation in which methane and propane gases are leaked with an about 1.2 cm thick layer and a globe having an about 20 cm, in which case the volumes of leaked cases double. Referring to FIG. 16, it may be seen that the correlation coefficient decreases if a gas is leaked, and the value is proportional to a volume.

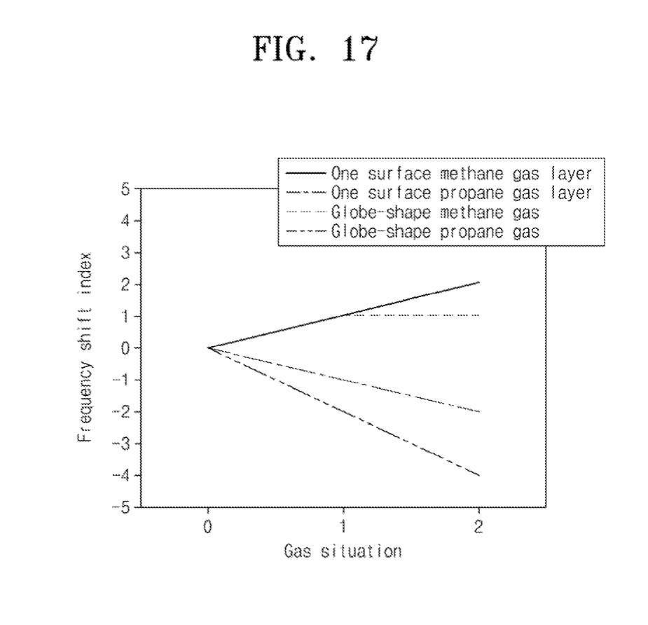

FIG. 17 shows a frequency shift index for the respective cases of FIGS. 12A to 15B. It may be seen that in the case of a methane gas, a frequency shits toward the high frequency and in the case of a propane gas, a frequency shifts toward the low frequency. Also, it may be seen that with an increase in an amount of leak gas, the frequency shift index increases. Referring to FIGS. 16 and 17, it is possible to monitor a variation in correlation coefficient to sense whether a gas leak has occurred and it is possible to monitor the frequency shift index to identify a leak gas. Also, it is also possible to monitor the variation speed of the correlation coefficient and the speed of the frequency shift to sense an amount of leak gas.

In the case where the density of a gas and the sound speed are different from those at room temperature because the temperature of the leak gas is low or high, the direction of the frequency shift may vary in spite of the same type of gas. For example, if the temperature of a leaked methane gas is low, the speed of a sound wave may decrease in comparison to the air, in which case the frequency shift may appear in the direction of the low frequency.

A gas monitoring method according to an embodiment of the inventive concept calculates the cross correlation coefficient between a reference sound field and a predetermined number of continuous sound fields from a sound spectrum field that is obtained through continuous measurement. In addition, the correlation coefficient in the case where a frequency has not shifted, m=0 is monitored. In the case where the monitored correlation coefficient is smaller than a predetermined reference value, e.g., 1, it is determined that gas leak and mixing situations have occurred. The correlation coefficient is a criterion that has quantified a correlation that determines how similar two spectra are. The determination reference value may also be set to a certain value equal to or lower 1 according to the environment or condition. The determination reference value according to an embodiment of the inventive concept may be set to about 0.98 but is not limited thereto.

A gas monitoring method according to another embodiment of the inventive concept may further include repeating sound field measurement or increasing the size of a sound source to measure a sound transfer function to check a sound field variation due to the occurrence of gas leak and mixing situations. The reason is that a sound field value may instantly have wrong data by the external noise or the electrical noise of a sound device and thus there is a need to minimize the malfunction issue of sound field based gas monitoring that may occur due to this and to increase reliability. Since the correlation coefficient uses a relative deviation from an average regardless of the absolute amplitude of a sound field, the correlation coefficient has the same value regardless of the size of a sound source in the case where the sound source is significantly large in comparison to surrounding environmental noise. Thus, even when using a sound pressure level of a sound receiving device itself, not a sound transfer function that a voltage applied to a sound generating device is considered, to obtain the correlation coefficient, the same result may be obtained regardless of an amplitude variation of the sound source.

Since a sound field spectrum may sensitively vary by an ordinary temperature variation due to a daily temperature range, air conditioning and heating as well as a gas leak, it is difficult to accurately identify a gas leak situation by simple measurement of the correlation coefficient. Thus, in order to solve this limitation, there is a need to distinguish situations where a sound field sharply varies, such as gas leak and mixing situations from situations where a sound field gradually varies, such as a temperature variation due to a daily temperature range and air conditioning and heating. In the case of the gas leak and mixing situations, a uniform correlation coefficient is maintained before the gas leak, and the correlation coefficient sharply decreases when the gas leak occurs, and in the case of the ordinary temperature variation, the correlation coefficient gradually decreases.

In the case where it is determined as gas leak and mixing situations, a gas monitoring method according to an embodiment of the inventive concept may cope with a gas leak situation through the processes of ringing the alarm that indicates the gas leak situation, capturing, storing and transmitting an image of a gas monitoring space.

As described above, a gas monitoring method based on sound field variation pattern sensing using the correlation coefficient of a sound field spectrum may ring the alarm according to a gas leak or mixing situation. Also, it is possible to store an image of gas leak and mixing situations in conjunction with a camera module, such as a CCTV or store the image to a set destination. Here, the destination may be a smart device of a specific person, such as a smart phone and a tablet PC, a janitor's room server, a security and disaster prevention company server, a fire station server or the like.

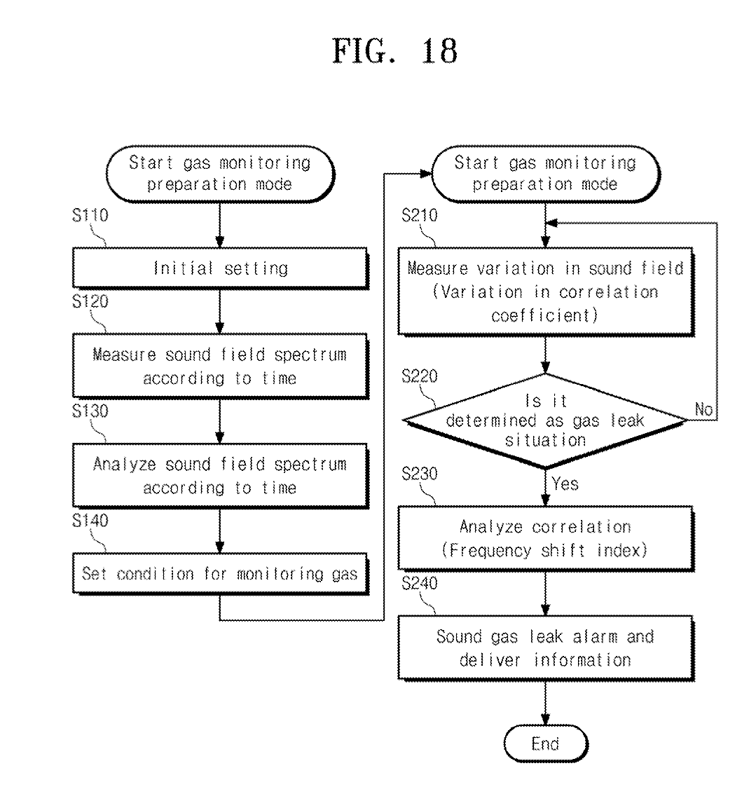

FIG. 18 is a flowchart of a gas monitoring method that senses gas leak and mixing situations based on the correlation coefficient of sound field spectra according to an embodiment of the inventive concept. Referring to FIG. 18, the gas monitoring method according to an embodiment of the inventive concept may be divided into a gas monitoring preparation mode and a gas monitoring mode.

The gas monitoring preparation mode may include performing an initial setting in step S110, measuring a sound field spectrum according to time in step S120, analyzing a sound field spectrum according time in step S130, and setting a gas monitoring condition in step S140.

The gas monitoring mode may include measuring a variation in sound field spectrum for measuring a variation in correlation coefficient in step S210, determining whether a gas leak has occurred in step S220, identifying and verifying a gas through correlation coefficient analysis in step S230, and sounding a gas leak alarm and delivering information in step S240.

In step S110, the sound generator 110 outputs a sound wave according to an output voltage of the sound control unit 134 into a gas monitoring space. The sound receiver 120 receives the sound wave in the gas monitoring space. The sound field signal processor 130 measures a sound field spectrum for a reference sound field (sound pressure, phase) according to frequency that is provided from the sound receiver 120. Measured sound field spectrum information is stored in the internal memory 138.

In step S120, the sound field signal processor 130 measures a sound pressure signal according to a time variation according to frequency and compares a result of measurement with sound pressure spectrum information according to reference frequency, in order to measure a sound field spectrum according to time.

In step S120, the sound field signal processor 130 analyzes the measured a sound field spectrum according to time and then stores, in the memory 138, a correlation coefficient that is an index value, a numerical value of the correlation between sound field spectra according to time.

In step S140, the sound field signal processor 130 sets an initialization time period and a gas sensing situation determination reference value of the correlation coefficient with reference to the stored correlation coefficient value according to time.

If the above-described gas monitoring preparation mode is completed, the setting of reference values for determining whether there is a gas leak would be completed. In the case where the gas monitoring preparation mode is completed, the gas monitoring apparatus 100 according to the inventive concept would perform a gas monitoring operation in the gas monitoring space.

In step S210, the sound field signal processor 130 measures a current sound pressure spectrum for each frequency and calculates a correlation coefficient with a reference sound field spectrum. In this case, the sound field signal processor 130 may re-set the reference sound field spectrum at an interval of the initialization time period.

As another embodiment, it is also possible to use a method in which a measured sound field before a predetermined section is set a reference sound field and the reference sound field sequentially moves backward by one measurement each time a sound field is measured in real time. Such a method has an advantage in that it is possible to perform comparison and measurement on a variation in sound field in the same period where comparison is performed on a reference sound field before a designated number of sections. Also, it is possible to select a method in which the measured initial sound field is fixed as the reference sound field until the sound field measurement of a certain number of sections is completed, and the reference sound field is extended to a virtual preceding sound field in a corresponding period, or it is possible to select a method in which it is unconditionally determined as a gas leak condition when a variation in sound field occurs before measurements of the designated number of sections are completed. Typically, this section may be set as an initialization period.

In step S220, the sound field signal processor 130 compares a current sound field spectrum for each frequency with a reference sound field spectrum for each frequency to determine whether a gas leak situation occurs. In particular, the sound field signal processor 130 may determine that a gas leak situation causing a variation in sound field has occurred in the case where the correlation coefficient between the reference sound field spectrum and the sensed sound field spectrum is smaller than a set reference value.

In the case where it is determined that gas leak and mixing situations have occurred, the sound field signal processor 130 analyzes a variation in the correlation coefficient on a sound field spectrum in a certain section right before the gas leak situation occurs, in step S230 in this case, the reference sound field spectrum is re-set as an initial sound field spectrum before a predetermined number of sections. Here, it is possible to identify whether a variation in the correlation coefficient varies sharply or gradually according to time, to identify whether the variation in sound field is caused by a gas leak or by a temperature variation.

In an embodiment, when the analysis section unit of a sound field spectrum is set as a short section in step S230, a sharply varying sound field spectrum may be selectively sensed. In most rapid gas leak situations, it is possible to compare a variation in correlation coefficient to distinguish it from a relatively significantly slow variation in temperature and even in most temperature variation situations, it is possible to selectively sense a gas leak situation.

However, in this case, it is difficult to sense a detailed variation situation of a sound field spectrum by a slow gas leak. Thus, it is possible to use a method in which an operation process of setting and analyzing the analysis section unit of a sound field spectrum to a relatively long section is together performed to compare a result of sensing a variation in sound field spectrum according to two section conditions and accordingly identify a rapid gas leak or slow gas leak situation. In this case, it is possible to differently apply the determination reference value of a correlation coefficient variation to a rapid gas leak or a slow gas leak in a short section or a long section to adjust the sensitivity and speed of gas leak sensing.

If it is determined as a gas leak situation and frequency shift analysis is performed, a variation in cross correlation coefficient according to a frequency shift is analyzed and a frequency shift index is calculated, in step S230. The frequency shift index may be used for identifying the types of leak gases.

If in step S230, it is determined as a gas leak situation, a camera module (not shown) operates under the control of the sound field signal processor 130 in order to accurately verify it, and it is possible to further perform capturing an image and storing a captured image.

In step S240, the alarm unit 150 may sound a gas leak alarm in response to the notification signal of the sound field signal processor 130. Also, the image captured through the camera module may be transmitted to a mobile phone, a smart device, a server of a janitor's room or a security and disaster prevention company through the communication unit 140 that is connected to a wired or wireless communication network.

In another embodiment, an apparatus and method of monitoring gas leak and mixing based on a variation in sound field may be used along with various gas sensors that directly and indirectly sense a gas. By further using various gas sensors, it is possible to enhance the sensing speed, sensitivity, reliability and accuracy in sensing a gas leak and identifying a type of gas. A gas sensor that is further used may include at least one of a semiconductor type, catalytic combustion method, hot wire type, ceramic thin film type, optical, piezoelectric, electrochemical, or solid electrolyte type gas sensor.

In another embodiment, it is possible to further apply a security monitoring apparatus and method that monitors instruction and fire based on a variation in sound field to the apparatus and method that senses a gas leak based on a variation in sound field. According to such an embodiment, it is possible to widely use various sensors sensing intrusion, fire, and movement to implement a comprehensive security and disaster prevention monitoring apparatus and method.

As various usage examples, the gas monitoring apparatus to which such a gas monitoring method is applied may be connected to an internet phone to be used in integral and external types. The gas monitoring method may also be applied to various kinds of smart devices, such as a smart phone, a smart TV, a smart vehicle, or a smart appliance including an interphone.

One or more modules gas monitoring apparatuses 100 according to the inventive concept may be installed inside home, an office, a store, a factory, and a warehouse that are set as gas monitoring spaces, and each of them may operate independently or through a wired or wireless connection. The gas monitoring apparatus 100 may be integrated with the sound generator 110, the sound receiver 120, and the sound field signal processor 130. However, in the case where a gas monitoring space range is too wide or a structure thereof is too complex to secure reliable gas monitoring, a system configuration may also be possible in such a manner that a plurality of pairs of sound generators 110 and sound receivers 120 are connected around the sound field signal processor 130 in a wired manner or operate in conjunction with the sound field signal processor 130 through a short range communication module, such as WiFi.

Also, while all people are out, it is possible to configure a multi-tone sound source as a audio frequency band and while there is a person, it is possible to selectively operate as a multi-tone sound source of a frequency of about 15 kHz or higher. In this case, it is possible to solve a noise issue according to the operation of the gas monitoring apparatus 100. Also, in the case where a person is in a limited indoor space or in sleep, it is possible to set a gas tank, a gas valve, a gas pipe and cooking utensils as main gas monitoring spaces to solve a noise issue due to the operation of the gas monitoring apparatus 100. Since the wavelength of a sound wave is long in the audio frequency band of about 20 Hz to about 15 kHz and there is no blind spot due to the internal structure of the gas monitoring space, it is possible to widely monitor a gas leak. On the contrary, in the case where a hearing loss or inaudible frequency band of about 15 kHz or higher is used as the multi-tone sound source, it is possible to monitor a gas leak in a narrow region because the wavelength of sound shortens.

The gas monitoring method using a variation pattern of the correlation coefficient of a sound field spectrum according to an embodiment of the inventive concept may be implemented in software, in which case it is possible to perform a gas monitoring operation without the hardware change of an existing internet phone or smart device. That is, it is possible to embed the related algorithm in an internal processor to perform the gas monitoring operation.

Gas monitoring information that the gas monitoring apparatus 100 according to an embodiment of the inventive concept senses may be transmitted as texts and multimedia information, such as images to various smart devices through a wired/wireless network. Also, in the case where a user of a smart phone or smart device accesses a related security and disaster prevention system through an app, it is also possible to provide various services related to security and disaster prevention.

According to the inventive concept, it is possible to measure the presence and absence of gas leak and mixing that occur at any position in any gas monitoring space regardless of the shape of a gas monitoring space.

Although particular embodiments have been provided in the detailed description of the inventive concept, there may be many variations without departing from the scope of the inventive concept. Therefore, the scope of the inventive concept should not be limited to the above-described embodiments but should be defined by equivalents of the following claims as well as the following claims.

What is claimed is:

1. A gas monitoring apparatus comprising:
a sound generator configured to continuously output a sound signal into a gas monitoring space;
a sound receiver configured to receive a sound signal reflected from the gas monitoring space; and
a sound field signal processor configured to obtain sound field information on the received sound signal, calculate a sound field spectrum for the sound field information, use a correlation between the calculated sound field spectrum and a reference sound field spectrum, and determine whether there are gas leak and mixing in the gas monitoring space,
wherein the reference sound field spectrum is a sound field spectrum according to frequency measured in a case where a gas is not leaked in the gas monitoring space, and the sound signal is formed by a linear sum of sine waves that have a plurality of frequency components.

2. The gas monitoring apparatus of claim 1, wherein the correlation is obtained by calculating of a cross correlation coefficient between the reference sound field spectrum and the sound field spectrum of the continuously output sound signal.

3. The gas monitoring apparatus of claim 1, wherein the cross correlation coefficient is calculated by using an equation below:
$${R}_{i , j} ( m ) = \frac{{\sum }_{n = 1}^{N - m} ( {S}_{j} ( n + m ) - mean ( {S}_{j} ) ) ( {S}_{i} ( n ) - mean ( {S}_{i} ) )}{\sqrt{{\sum }_{n = 1}^{N} {( {S}_{i} ( n ) - mean ( {S}_{i} ) )}^{2}} \sqrt{{\sum }_{n = 1}^{N} {( {S}_{j} ( n ) - mean ( {S}_{j} ) )}^{2}}} , m \geq 0 , \\ {R}_{i , j} ( m ) = {R}_{j , i} ( - m ) , m < 0$$
where R_{i,j} denotes a cross correlation coefficient between an ith measured sound field Sᵢ, and jth measured sound field Sⱼ, N denotes the number of channels of a multi-tone sound source, and m denotes a neighboring frequency interval of the multi-tone sound source as a unit of frequency shift value.

4. The gas monitoring apparatus of claim 1, wherein the sound field information is sound pressure or a phase of the sound signal, and the sound field signal processor uses a sound transfer function to calculate the sound pressure or phase.

5. The gas monitoring apparatus of claim 1, wherein the sound field signal processor is configured to calculate an index representing a frequency shift level of the sound field spectrum based on a correlation coefficient that is obtained when a multi-tone frequency between the reference sound field spectrum and the sound field spectrum of the continuous sound signal is used as a variable, and sense a type of leak gas, an amount of leak gas, and a leak speed in consideration of a direction of the frequency shift and a time for which the frequency shift is sustained.

6. The gas monitoring apparatus of claim 1, wherein the sound field signal processor is configured to compare the reference sound field spectrum and the measured sound field spectrum to determine as a gas leak situation in a case where a variation in sound field occurs, and analyze sound field spectra collected for a set period before determining the gas leak situation to sense an amount of leak gas.

7. The gas monitoring apparatus of claim 6, wherein the sound field signal processor is configured to analyze a variation pattern of a sound field spectrum according to time to sense a type of leak gas and a leak speed.

8. The gas monitoring apparatus of claim 1, wherein the sound field signal processor is configured to further obtain sensing information from a gas sensor installed in the gas monitoring space, and further use the obtained sensing information to calculate a type of leak gas and an amount of leak gas.

9. The gas monitoring apparatus of claim 1, further comprising an image capturing unit that is configured to obtain internal image information on of the gas monitoring space, wherein the image capturing unit is configured to capture an internal image of the gas monitoring space in a case where gas leak and mixing situations occur.

10. The gas monitoring apparatus of claim 1, further comprising a communication unit that is configured to transmit, to an external device, presence and absence of a gas leak, a type of gas, an amount of leak gas, a leak speed, and image information.

11. A method of monitoring gas leak and mixing, the method comprising
outputting, to a gas monitoring space, a multi-tone sound wave formed by a linear sum of sine waves that have a plurality of frequency components;
receiving the output multi-tone sound wave;
deriving sound field information on the received multi-tone sound wave and using the derived sound field information to obtain a sound field spectrum according to frequency;
calculating a cross correlation coefficient between the obtained sound field spectrum according to frequency and a reference sound field spectrum; and
comparing the calculated cross correlation coefficient with a set determination reference value to determine presence and absence of gas leak and mixing.

12. The method of claim 11, wherein the cross correlation coefficient is calculated by using an equation below:
$${R}_{i , j} ( m ) = \frac{{\sum }_{n = 1}^{N - m} ( {S}_{j} ( n + m ) - mean ( {S}_{j} ) ) ( {S}_{i} ( n ) - mean ( {S}_{i} ) )}{\sqrt{{\sum }_{n = 1}^{N} {( {S}_{i} ( n ) - mean ( {S}_{i} ) )}^{2}} \sqrt{{\sum }_{n = 1}^{N} {( {S}_{j} ( n ) - mean ( {S}_{j} ) )}^{2}}} , m \geq 0 , \\ {R}_{i , j} ( m ) = {R}_{j , i} ( - m ) , m < 0$$
where R_{i,j} denotes a cross correlation coefficient between an ith measured sound field Sᵢ, and jth measured sound field Sⱼ, N denotes the number of channels of a multi-tone sound source, and m denotes a neighboring frequency interval of the multi-tone sound source as a unit of frequency shift value.

13. The method of claim 11, wherein the sound field information is sound pressure or a phase of the sound signal, and a sound field signal processor uses a sound transfer function to calculate the sound pressure or phase.

14. The method of claim 11, further comprising calculating an index representing a frequency shift level of the sound field spectrum based on a correlation coefficient that is obtained when a multi-tone frequency between the reference sound field spectrum and the sound field spectrum of the continuous sound signal is used as a variable, and sensing a type of leak gas, an amount of leak gas, and a leak speed in consideration of a direction of the frequency shift and a time for which the frequency shift is sustained.

15. The method of claim 11, further comprising capturing an internal image of the gas monitoring space in a case where it is determined as gas leak and mixing situations.
